(19) United States
(12) Patent Application Publication
(10) Pub. No.: US 2023/0096078 A1
(43) Pub. Date: Mar. 30, 2023

(54) RIG ACTIVITY MANAGEMENT

(71) Applicant: Nabors Drilling Technologies USA, Inc., Houston, TX (US)

(72) Inventor: Pradeep ANNAIYAPPA, Houston, TX (US)

(21) Appl. No.: 17/934,588

(22) Filed: Sep. 23, 2022

Related U.S. Application Data
(60) Provisional application No. 63/261,819, filed on Sep. 29, 2021.

(51) Int. Cl. G06Q 10/06; G06Q 50/02; E21B 19/16; E21B 41/00

(52) U.S. Cl. CPC G06Q 10/0635; G06Q 10/063114; G06Q 50/02; E21B 19/165; E21B 41/00

(57) ABSTRACT

A method for conducting operations in an environment that can include conducting an activity of a well plan within an environment, obtaining individual data from an electronic device on an individual, calculating an individual risk score of the individual for performing a task in support of the activity, and calculating an activity risk score for the activity based at least in part on the individual risk score.

### CROSS-REFERENCE TO RELATED APPLICATION(S)

This application claims priority under 35 U.S.C. § 119(e) to U.S. Provisional Application No. 63/261,819, entitled “RIG ACTIVITY MANAGEMENT,” by Pradeep ANNAIYAPPA, filed Sep. 29, 2021, which is assigned to the current assignee hereof and incorporated herein by reference in its entirety.

### TECHNICAL FIELD

The present invention relates, in general, to the field of drilling and processing of wells. More particularly, present embodiments relate to a system and method for analyzing and determining proficiency and risk scores of rig equipment and individuals to perform activities according to a well plan or a rig plan.

### BACKGROUND

During well construction operations, activities on a rig can be organized according to a well plan. The well plan can be converted to a rig plan (i.e., rig specific well construction plan) for implementation on a specific rig. Deviations from the well plan or rig plan can cause rig delays, increase well site operation costs, and cause other impacts to operations. Poorly performed well plan activities or rig plan tasks on the rig can cause delays or even unplanned activities or tasks if the activity or task is in a high priority path. Delays in identifying the poor performance can exacerbate these impacts. Therefore, improvements in rig activity monitoring and reporting are continually needed.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for conducting operations in an environment. The method can include conducting an activity of a well plan within an environment; obtaining individual data from an electronic device on an individual, calculating an individual risk score of the individual for performing a task in support of the activity, and calculating an activity risk score for the activity based at least in part on the individual risk score. Other embodiments of this aspect include corresponding computer systems, apparatus, and computer programs recorded on one or more computer storage devices, each configured to perform the actions of the methods.

One general aspect includes a method for conducting operations in an environment. The method can include conducting an activity of a well plan within an environment, identifying, via an imaging system, an individual in the environment, obtaining individual data from an electronic device on the individual, calculating an individual risk score of the individual for performing a task in support of the activity, and calculating an activity risk score for the activity based at least in part on the individual risk score. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIG. 1A is a representative simplified front view of a rig being utilized for a subterranean operation, in accordance with certain embodiments;

FIG. 1B is a representative simplified view of a user using possible wearable devices for user input or identification, in accordance with certain embodiments;

FIG. 2 is a representative partial cross-sectional view of a rig being utilized for a subterranean operation, in accordance with certain embodiments;

FIG. 3A is a representative front view of various users being detectable via an imaging system, in accordance with certain embodiments;

FIG. 3B is a representative flow diagram of a method for detecting and determining an identity of an individual via the imaging system, in accordance with certain embodiments;

FIG. 4 is a representative flow diagram of a method for calculating an activity proficiency score for an activity of a well plan, in accordance with certain embodiments;

FIG. 5 is a representative block diagram of an environment with multiple zones at a rig site, in accordance with certain embodiments;

FIG. 6 is a representative functional block diagram of a method using a computer to determine risk scores for various individuals and activities, in accordance with certain embodiments;

FIG. 7 is a representative functional block diagram of a method using a computer to determine proficiency scores for various individuals and activities, in accordance with certain embodiments;

FIG. 8A is a representative list of well activities for an example digital well plan, in accordance with certain embodiments;

FIG. 8B is a representative functional diagram that illustrates conversion of well plan activities to rig plan tasks, in accordance with certain embodiments;

FIG. 9 is a representative flow diagram that shows secondary tasks in support of primary activities/tasks, in accordance with certain embodiments; and

FIG. 10 is a representative functional diagram of a computing system (such as a rig controller) that illustrates rig controller functions and possible databases that can be used to convert a digital well plan to a digital rig plan, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

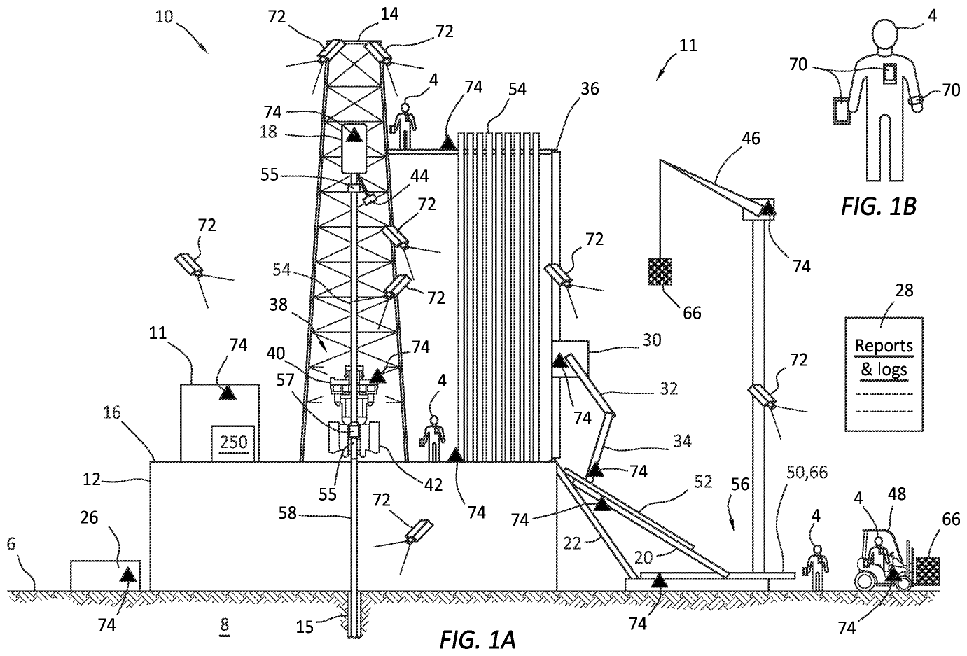

As used herein, “tubular” refers to an elongated cylindrical tube and can include any of the tubulars manipulated around a rig, such as tubular segments, tubular stands, tubulars, and tubular string, but not limited to the tubulars shown in FIG. 1A. Therefore, in this disclosure, “tubular” is synonymous with “tubular segment,” “tubular stand,” and “tubular string,” as well as “pipe,” “pipe segment,” “pipe stand,” “pipe string,” “casing,” “casing segment,” or “casing string.”

FIG. 1A is a representative simplified front view of a rig 10 at a rig site 11 being utilized for a subterranean operation (e.g., tripping in or out a tubular string to or from a wellbore), in accordance with certain embodiments. The rig site 11 can include the rig 10 with its rig equipment, along with equipment and work areas that support the rig 10 but are not necessarily on the rig 10. The rig 10 can include a platform 12 with a rig floor 16 and a derrick 14 extending up from the rig floor 16. The derrick 14 can provide support for hoisting the top drive 18 as needed to manipulate tubulars. A catwalk 20 and V-door ramp 22 can be used to transfer horizontally stored tubular segments 50 to the rig floor 16. A tubular segment 52 can be one of the horizontally stored tubular segments 50 that is being transferred to the rig floor 16 via the catwalk 20. A pipe handler 30 with articulating arms 32, 34 can be used to grab the tubular segment 52 from the catwalk 20 and transfer the tubular segment 52 to the top drive 18, the fingerboard 36, the wellbore 15, etc. However, it is not required that a pipe handler 30 be used on the rig 10. The top drive 18 can transfer tubulars directly to and directly from the catwalk 20 (e.g., using an elevator coupled to the top drive).

The tubular string 58 can extend into the wellbore 15, with the wellbore 15 extending through the surface 6 into the subterranean formation 8. When tripping the tubular string 58 into the wellbore 15, tubulars 54 can be sequentially added to the tubular string 58 to extend the length of the tubular string 58 into the earthen formation 8. FIG. 1A shows a land-based rig. However, it should be understood that the principles of this disclosure are equally applicable to off-shore rigs where “off-shore” refers to a rig with water between the rig floor and the earth surface 6.

When tripping the tubular string 58 out of the wellbore 15, tubulars 54 can be sequentially removed from the tubular string 58 to reduce the length of the tubular string 58 in the wellbore 15. The pipe handler 30 can be used to remove the tubulars 54 from an iron roughneck 38 or a top drive 18 at a well center 24 and transfer the tubulars 54 to the catwalk 20, the fingerboard 36, etc. The iron roughneck 38 can break a threaded connection between a tubular 54 being removed and the tubular string 58. A spinner assembly 40 (or pipe handler 30) can engage a body of the tubular 54 to spin a pin end 57 of the tubular 54 out of a threaded box end 55 of the tubular string 58, thereby unthreading the tubular 54 from the tubular string 58.

When tripping the tubular string 58 into the wellbore 15, tubulars 54 are sequentially added to the tubular string 58 to increase the length of the tubular string 58 in the wellbore 15. The pipe handler 30 can be used to deliver the tubulars 54 to a well center on the rig floor 16 in a vertical orientation and hand the tubulars 54 off to an iron roughneck 38 or a top drive 18. The iron roughneck 38 can make a threaded connection between the tubular 54 being added and the tubular string 58. A spinner assembly 40 or pipe handler 30 can engage a body of the tubular 54 to spin a pin end 57 of the tubular 54 into a threaded box end 55 of the tubular string 58, thereby threading the tubular 54 into the tubular string 58. The wrench assembly 42 can provide a desired torque to the threaded connection, thereby completing the connection.

While tripping a tubular string into or out of the wellbore 15 can be a significant part of the operations performed by the rig, many other rig tasks are also needed to perform a well construction according to a digital well plan. For example, pumping mud at desired rates, maintaining downhole pressures (as in managed pressure drilling), maintaining and controlling rig power systems, coordinating and managing personnel on the rig during operations, performing pressure tests on sections of the wellbore 15, cementing a casing string in the wellbore, performing well logging operations, as well as many other rig tasks. As used herein, “personnel”, “individual”, “user”, or “operator” can be used interchangeably in that each refers to a human that is available to support a subterranean operation.

A rig controller 250 can be used to control the rig 10 operations including controlling various rig equipment, such as the pipe handler 30, the top drive 18, the iron roughneck 38, the fingerboard equipment, imaging systems, various other robots on the rig 10 (e.g., a drill floor robot), rig power systems 26, or sending instructions to individuals on the rig. The rig controller 250 can control the rig equipment autonomously (e.g., without periodic operator interaction), semi-autonomously (e.g., with limited operator interaction such as initiating a subterranean operation, adjusting parameters during the operation, etc.), or manually (e.g., with the operator interactively controlling the rig equipment via remote control interfaces to perform the subterranean operation).

A proficiency score can be determined (e.g., by the controller 250) for an individual or rig equipment used in performing a task of a subterranean operation. The proficiency score can indicate a proficiency or competency of the individual or rig equipment to perform the task according to the well plan 100 or rig plan 102. The proficiency scores for the individual can indicate if the individual has performed the task satisfactorily in the past (e.g., performed the task on time, in the right location, and with the correct resources). Depending on the proficiency score of the individual, it can also indicate a need for additional skills training for the individual. The proficiency score for the rig equipment can indicate that the equipment has performed the task satisfactorily in the past, or that the equipment may need maintenance or repair. As used herein, “satisfactorily perform”, “satisfactorily performs”, or “performed satisfactorily”, refers to a performance of a task or activity that is within the performance guidelines or budgets provided in the digital well plan 100 or the digital rig plan 102.

Therefore, as used herein, a “proficiency score” refers to an indication as to an established ability or competency of an individual, a piece of rig equipment, or a rig 10 (which may include personnel) to perform a task of a digital rig plan 102 to execute a digital well plan 100 on the rig 10 based on prior performances or training. The proficiency score can be updated in real-time as data sources provide real-time data to the rig controller 250 associated with the real-time performance of the individual, rig equipment, or rig 10 to the digital well plan 100. This real-time proficiency score can continue to be updated as the task is performed. Once the task is completed, the final real-time proficiency score for the individual or rig equipment can be stored in a database or other storage means (e.g., entry in a log or report) as historical proficiency data, which can be used for future risk score calculations. The proficiency score can be used to adapt future digital well plans, which can be modified to accommodate or take advantage of the proficiency scores of the individuals, the rig equipment, or the rig 10 (or rig site 11).

A risk score can be determined (e.g., by the rig controller 250) for individual(s) or rig equipment used in performing a task of a subterranean operation. The risk score can indicate a probability that the individual(s) or rig equipment assigned to perform a task can satisfactorily perform the task according to the well plan or rig plan. The risk score for the individual can indicate the probability that the individual can perform the task satisfactorily (e.g., perform the task on time, in the right location, or with the correct resources). For example, the risk scores for the rig equipment can indicate that the equipment is healthy and able to satisfactorily perform the tasks. For example, the risk scores for the rig equipment can indicate that the equipment may need maintenance or repair before being used to perform the tasks. The risk scores for the individual(s) and the rig equipment can be evaluated by the rig controller 250 to determine the overall risk score for the activity. Depending on the risk score, it can also indicate if modifications to the rig plan are needed to mitigate the risk of the performance of either the individual or the rig equipment. The risk scores can indicate if additional individuals or rig equipment are needed, other individuals or rig equipment are needed, training of the individual is needed, or maintenance of the rig equipment is needed to execute the tasks. For example, if using a mud pump for a rig task has a high risk score, then the mud pump may be replaced by a mud pump with a lower risk score, or possibly taken off-line for repairs while a standby mud pump is brought online to support the task and reduce the risk score for the task.

Therefore, as used herein, a “risk score” refers to a probability that the individual or the rig equipment can perform an assigned task of a rig plan or activity of a well plan. The risk score can include an initial risk score component and a real-time risk score component. The initial risk score component can be determined from historical risk data associated with the individual or the rig equipment, where the historical risk data can be stored in a database readable by the rig controller 250 or otherwise provided to the rig controller 250. The historical risk data can include how many times and how well the individual or rig equipment completed a previously assigned task prior to execution of the assigned task. The historical risk data can be analyzed by simulation or machine learning to determine trends, such as if the performance of a piece of rig equipment or an individual is progressively decreasing or increasing or staying generally constant. Adaptions to the rig plan can be made to take advantage of or accommodate these trends.

The real-time risk score component can be determined by data from various data sources (e.g., sensors) on the individual, on the rig equipment, or remotely positioned from either the individual or rig equipment. The data sources can provide data associated with the performance of an assigned task, and the rig controller 250 can analyze the data to determine a performance level of the individual or rig equipment and combine it with the initial risk score component to produce a real-time risk score of the task being performed. This real-time risk score can continue to be updated as the task is performed. Once the task is completed, the final real-time risk score for the individual or rig equipment can be stored in a database or other storage means (e.g., entry in a log or report) as historical risk data, which can be used for future risk score calculations.

The rig controller 250 can include one or more processors with one or more of the processors distributed about the rig 10, such as in an operator's control hut 13, in the pipe handler 30, in the iron roughneck 38, in the vertical storage area 36, in the imaging systems, in various other robots, in the top drive 18, at various locations on the rig floor 16 or the derrick 14 or the platform 12, at a remote location off of the rig 10, at downhole locations, etc. It should be understood that any of these processors can perform control or calculations locally or can communicate to a remotely located processor for performing the control or calculations. Each of the processors can be communicatively coupled to a non-transitory memory, which can include instructions for the respective processor to read and execute to implement the desired control functions or other methods described in this disclosure or data stored in various databases. These processors can be coupled via a wired or wireless network. All data received and sent by the rig controller 250 is in a computer-readable format and can be stored in and retrieved from the non-transitory memory.

The rig controller 250 can collect data from various data sources around the rig (e.g., sensors 72, 74, electronic devices like wearables 70, user input, local rig reports, etc.) and from remote data sources (e.g., suppliers, manufacturers, transporters, company men, remote rig reports, etc.) to monitor and facilitate the execution of a digital well plan. A digital well plan is generally designed to be independent of a specific rig, where a digital rig plan is a digital well plan that has been modified to incorporate the specific equipment available on a specific rig and best practices to execute the well plan on the specific rig, such as rig 10. Therefore, the rig controller 250 can be configured to monitor and facilitate the execution of the digital well plan by monitoring and executing rig tasks in the digital rig plan.

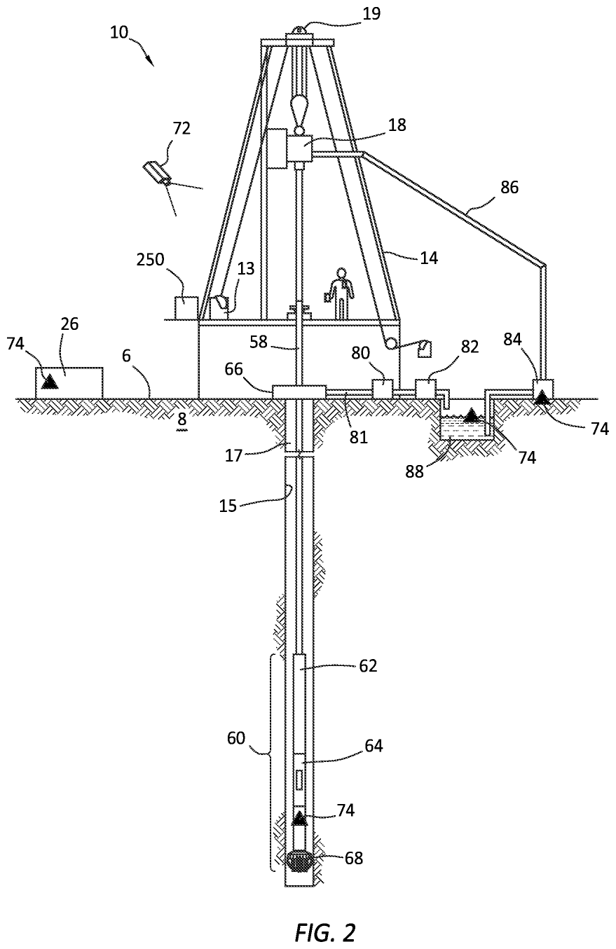

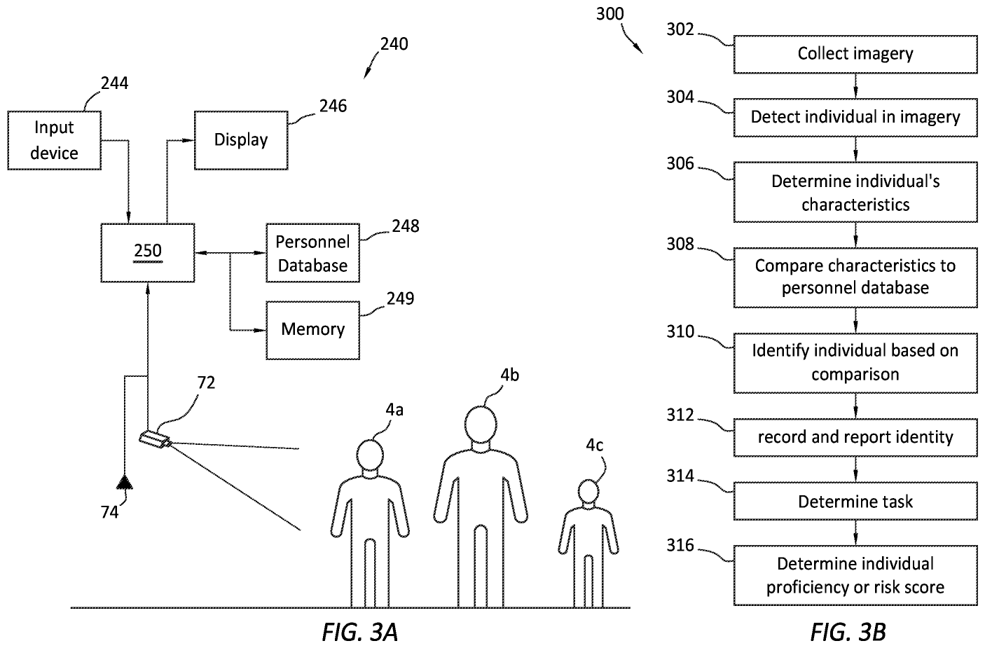

Examples of local data sources are shown in FIG. 1A where an imaging system (e.g., imaging system 240 in FIG. 3A) can include the rig controller 250 and imaging sensors 72 positioned at desired locations around the rig and around support equipment/material areas, such as mud pumps (see FIG. 2), horizontal storage area 56, power system 26, etc. to collect imagery of the desired locations. Also, various sensors 74 can be positioned at various locations around the rig site 11 and the support equipment/material areas to collect information from the rig equipment (e.g., pipe handler 30, roughneck 38, top drive 18, vertical storage 36, etc.) and support equipment (e.g., crane 46, forklift 48, horizontal storage area 56, power system 26, etc.) to collect operational parameters of the equipment. Additional information can be collected from other data sources, such as reports and logs 28 (e.g., tour reports, daily progress reports, reports from remote locations, shipment logs, delivery logs, personnel logs, etc.).

These data sources can be aggregated by the rig controller 250 and used to determine an estimated well activity of the rig and comparing it to the digital well plan to determine progress and performance of the rig 10 in executing the digital well plan.

The data sources can be received by the rig controller 250 and used to determine one or more tasks that are being performed at the rig site 11 by one or more individuals 4 or pieces of rig equipment in support of a well activity of the digital well plan. The rig controller 250 can use the data sources to determine if the one or more tasks being performed in support of the well activity are either primary tasks or secondary tasks. As used herein, a “primary task” is a task performed by rig equipment or an individual, where the task is executing a well activity of the digital well plan. As used herein, a “secondary task” is a task performed by rig equipment or an individual, where the task is supporting execution of the well activity of the digital well plan but is not directly executing the well activity. The secondary tasks can be performed simultaneously with the primary tasks but can also be performed at times other than simultaneously with the primary tasks.

The rig controller 250 can calculate a risk score for the individual 4 or rig equipment performing the primary task or secondary task based on data from the data sources or based on historical data from past performances of the individual 4 or rig equipment performing the task. The risk score can indicate an ability of the individual 4 or rig equipment to perform the specific task (primary or secondary).

The risk score can include a real-time individual risk score component that can be based at least in part upon comparing an expected characteristic of the individual to an actual characteristic of the individual. The expected or actual characteristics of the individual can include a position of the individual within the environment, movement of the individual within the environment, movement of one or more body parts of the individual within the environment, health signal(s) of the individual from sensors monitoring the individual 4 or the environment, conditions within the environment, or combinations thereof. The expected characteristics can be measured in real-time based upon data received from the data sources.

For example, the imaging system (e.g., imaging system 240 in FIG. 3A) can detect a position of the individual 4 within the environment being monitored and the rig controller 250 can compare the position to an expected position, where the expected position can be stored in a database for retrieval as needed by the rig controller 250.

For example, the imaging system can detect movement of the individual 4 within the environment, and the rig controller 250 can compare the movement to an expected movement of the individual 4, where the expected movement can be stored in a database for retrieval as needed by the rig controller 250.

For example, the imaging system can detect movement of one or more body parts of the individual 4 within the environment and the rig controller 250 can compare the movement of the one or more body parts to an expected movement of the one or more body parts of the individual 4, where the expected movement of the one or more body parts of the individual 4 can be stored in a database for retrieval as needed by the rig controller 250.

For example, the imaging system can receive one or more health signals from sensors monitoring the individual 4 within the environment, and the rig controller 250 can compare the health signals to expected health signals of the individual 4, where the expected health signals can be stored in a database for retrieval as needed by the rig controller 250.

For example, the imaging system can receive one or more health signals from sensors monitoring the environment, and the rig controller 250 can compare the health signals to expected health signals of the environment, where the expected health signals can be stored in a database for retrieval as needed by the rig controller 250.

For example, the imaging system can detect conditions within the environment and the rig controller 250 can compare the conditions to expected conditions within the environment, where the expected conditions can be stored in a database for retrieval as needed by the rig controller 250.

The risk score can be determined via the rig controller 250 by using artificial intelligence, such as a machine learning program, which can use historical risk data for the individual 4 or the piece of rig equipment to estimate the real-time risk score. The historical risk data can be input into an artificial intelligence engine of the rig controller 250 (e.g., a neural network for deep learning), which can learn the historical risk data for the individual 4 (or rig equipment) and use this learning to predict a risk score for an individual or rig equipment to perform an assigned task. The risk score can be sent to one or more individuals 4 via respective electronic devices (e.g., wearable electronics, portable electronics, etc.), stored in a database, or fed back into the artificial intelligence engine for further learning. As used herein, “machine learning” refers to a branch of artificial intelligence (AI) which focuses on the use of data and algorithms to imitate the way that humans learn, gradually improving its accuracy through learning.

The data sources can include electronic devices such as the wearables 70 or sensors 72, 74. The wearables 70 (e.g., a smart wristwatch, a smart phone, a tablet, a laptop, an identification badge, a wearable transmitter, etc.) can be worn by an individual 4 (or user 4) to identify the individual 4, deliver instructions to the individual 4, or receive inputs from the individual 4 via the wearable 70 to the rig controller 250 (see FIG. 1B). Network connections (wired or wireless) to the electronic devices can be used for communication between the rig controller 250 and the electronic devices for information transfer. For example, the electronic device can send data associated with the individual, on which the electronic device is carried, to the rig controller 250. The rig controller 250 can use the individual's data to determine a risk score for the individual to perform the assigned task. The electronic devices (e.g., the sensors 72, 74, and wearables 70) can also send data associated with one or more pieces of rig equipment to the rig controller 250. The rig controller 250 can use the sensor data to determine a risk score for each piece of rig equipment.

The wearables 70 (i.e., electronic devices) can include a unique identification number that is associated with a respective individual 4. The unique identification number can be detectable by one or more active or passive detection systems in the environment. For example, an active detection system can be an imaging system 240 and a passive detection system can be an RFID reader that detects RFID devices in the environment. One or more of the wearables 70 can include processors that can be included in the rig controller 250, and these processors can be configured to calculate the risk score of the individual for performing the task. Sensors or other electronic devices can detect movements and actions of one or more individuals 4 in the environment or health signals of the individuals and calculate risk scores based on this information.

An electronic device (e.g., wearables 70) can include a display configured to display, to the individual, an alert, a change to the activity, a change to the task, a status of the activity, an individual risk score, a sensitivity value, an activity risk score, an individual proficiency score, an activity proficiency score, or any combination thereof.

FIG. 2 is a representative partial cross-sectional view of a rig 10 at a rig site 11 being used to drill a wellbore 15 in an earthen formation 8. FIG. 2 shows a land-based rig, but the principles of this disclosure can equally apply to off-shore rigs, as well. The rig 10 can include a top drive 18 with a traveling block 19 used to raise or lower the top drive 18. A derrick 14 extending from the rig floor 16, can provide the structural support of the rig equipment for performing subterranean operations (e.g., drilling, treating, completing, producing, testing, etc.). The rig 10 can be used to extend a wellbore 15 through the earthen formation 8 by using a drill string 58 having a Bottom Hole Assembly (BHA) 60 at its lower end. The BHA 60 can include a drill bit 68 and multiple drill collars 62, with one or more of the drill collars including instrumentation 64 for LWD and MWD operations. During drilling operations, drilling mud can be pumped from the surface 6 into the drill string 58 (e.g., via pumps 84 supplying mud to the top drive 18) to cool and lubricate the drill bit 68 and to transport cuttings to the surface via an annulus 17 between the drill string 58 and the wellbore 15.

The returned mud can be directed to the mud pit 88 through the flow line 81 and the shaker 80. A fluid treatment 82 can inject additives as desired to the mud to condition the mud appropriately for the current well activities and possibly future well activities as the mud is being pumped to the mud pit 88. The pump 84 can pull mud from the mud pit 88 and drive it to the top drive 18 to continue circulation of the mud through the drill string 58.

Sensors 74 and imaging sensors 72 can be distributed about the rig and downhole to provide information on the environments in these areas as well as operating conditions, health of equipment or individuals 4, well activity of equipment, positions of individuals 4 at the rig site 11, movements or actions of the individuals 4 at the rig site 11, fluid properties, WOB, ROP, RPM of drill string, RPM of drill bit 68, etc.

FIG. 3A is a representative front view of various individuals 4 (e.g., individuals 4a, 4b, 4c) that can be detectable via an imaging system 240. The imaging system 240 can include the rig controller 250, one or more imaging sensors 72, and one or more other sensors 74 (e.g., acoustic sensors, radio frequency identification RFID sensors, etc.), which can be positioned away from (or remote from) the individual 4. Some of the sensors or wearables can be one or more electronic devices with wireless communication capabilities, which are worn or carried by the individual 4. When determining the current well activity or current task, it can be beneficial to detect how many individuals 4 are present on the rig 10, where they are, who they are, and what they are doing, as well as the rig equipment being used and the parameters of their use. For example, the imaging system 240 can be used to detect individuals 4 at the rig site 11, track their location as they move about the rig site 11, determine an identity of each of the individuals 4, determine the task each of the individuals is performing or is to perform, determine the time each individual should take to perform the task and compare it to the time each individual took to perform the task, score each individual 4 on a risk of satisfactorily performing the task of the digital rig plan, and score the individuals 4 on their proficiency of performing the task.

By receiving imagery from the one or more imaging sensors 72, or sensor data from other sensors 74 or other electronic devices, the rig controller 250 can analyze the sensor data to detect characteristics of the individuals (such as individuals 4a, 4b, 4c) captured by the imagery from the imaging sensor(s) or detected by the sensors 74 (e.g., acoustic sensors, RFID sensors, etc.). The rig controller 250 can compare the detected characteristics of each individual 4 (such as individuals 4a, 4b, 4c) with characteristics of individuals stored in the personnel database 248. The characteristics can include a detectable identification number (e.g., RFID device, bar code, QR code, etc.), physical characteristics, mannerisms, walking stride (or motion), body movements, silhouette, size, posture, body movements, facial features, or audible signals (e.g., via acoustic sensors 74). If the individual 4 is not included in the characteristics of individuals stored in the personnel database 248, the rig controller 250 can store the characteristics of the new individual in the personnel database 248 for future identification purposes.

The rig controller 250 can detect (or sense) an individual at the rig site 11 by using one or more sensors 72, 74, or electronic devices that are remotely positioned relative to the individual. The one or more sensors 72, 74 can communicate directly or indirectly to the rig controller 250, which can communicate to a wearable electronic device 70 disposed on the individual 4. The rig controller 250 can analyze information from the one or more sensors 72 74, the wearable electronic device 70, or electronic devices to confirm an identity of the individual 4. The information can include the detected characteristics of the individual 4. The individual 4 can also respond, via the wearable electronic device 70, to an inquiry from the rig controller 250 to the wearable electronic device 70 requesting confirmation of the individual's 4 identity. For example, a human machine interface provided by the wearable electronic device 70 such as a touch screen, can be used to receive input from the individual 4 to respond to the inquiry.

The rig controller 250 can detect (or sense) an individual in separate environments (e.g., red zone, drill floor, operator's control hut 13, fingerboard 36, etc.) at the rig site 11 by using the one or more sensors 72, 74. The rig controller 250 can also determine a proficiency score for each of one or more individuals 4 that is associated with one of more of the environments on the rig 10. Some environments on the rig 10 can be referred to as “safe zones,” “red zones,” and “no-go zones.” As used herein, a “safe zone” is an environment or area on the rig 10 that is designated as being safe for individuals 4 during rig operations. As used herein, a “red zone” is an environment or area on the rig 10 that is designated hazardous to individuals 4 during rig operations, but the individuals 4 are allowed to enter the red zone to perform necessary tasks. As used herein, a “no-go zone” is an environment or area on the rig 10 that is designated unsafe for individuals 4 during rig operations and individuals 4 should be prevented from entering the no-go zones.

Based on the comparison of the detected characteristics to the stored characteristics, the rig controller 250 can determine the identity of each individual 4. The rig controller 250 can compare the tasks being performed by each identified individual 4, determine a length of time the individual took (or is taking) to perform the task, compare the task and the duration of the task with the digital well plan 100, and determine a proficiency score for the individual 4. One or more individual 4 proficiency scores and rig equipment proficiency scores can be used to calculate (via the rig controller 250) an overall activity proficiency score for the well activity of the digital well plan 100 (or digital rig plan 102).

Based on the comparison of the detected characteristics to the stored characteristics, the rig controller 250 can also determine a risk score for each individual 4 for each task to be performed by each individual 4. One or more individual 4 risk scores and rig equipment risk scores can be used to calculate (via the rig controller 250) an overall activity risk score for performing the well activity of the digital well plan 100 (or digital rig plan 102).

The rig controller 250 can also determine a location at the rig site 11 of each individual 4 based on identification of the surroundings around the individual 4 in captured imagery or based on other sensor data. The rig controller 250 can record, report, or display the individual's identity, location at the rig site 11, proficiency scores for each individual 4, overall, well activity proficiency scores for performance of the rig 10 and individuals 4 to the digital well plan 100, risk scores for each individual 4, and overall well activity risk scores for performing tasks of the digital rig plan 102 on the rig 10 with the rig equipment or one or more individuals 4.

In a non-limiting embodiment, FIG. 3B is a representative flow diagram of a method 300 for using the rig controller 250 to determine an identity of an individual 4 at the rig site 11 using imagery from the imaging system 240. At operation 302, the rig controller 250 can autonomously (or as a result of a user request) collect imagery (or other sensor data from sensors 74) of one or more individuals 4 at the rig site 11 via the imaging sensor(s) 72 (or sensor(s) 74). At operation 304, the rig controller 250 can detect the one or more individuals via the imagery or sensor data. In operation 306, the rig controller 250 can analyze the imagery or sensor data to determine the characteristics of the individual 4. In operation 308, the rig controller 250 can compare the determined characteristics to characteristics in a personnel database 248. In operation 310, rig controller 250 can identify the individual 4 based on the comparison of the characteristics. In operation 312, the rig controller 250 can record the individual's identity and report the identity to other users. With the identity of each of the individuals determined, the rig controller 250 can compare the actual individuals to expected individuals in the well plan 100 and use the comparison to update an overall risk score or proficiency score for the current well activity.

After determining the unique identity of each individual 4, the rig controller 250 can determine a historical proficiency score of the individual 4 (which can indicate an expertise, a skill level, or an experience level of the individual 4) such as from a lookup table stored in non-transitory memory 249 which can be communicatively coupled to the rig controller 250. By knowing the unique identity of the individual, their historical proficiency score, and their location on the rig or in support areas, the rig controller 250 can assimilate this information along with the data from other various data sources to update an individual risk score or an individual proficiency score for each individual 4.

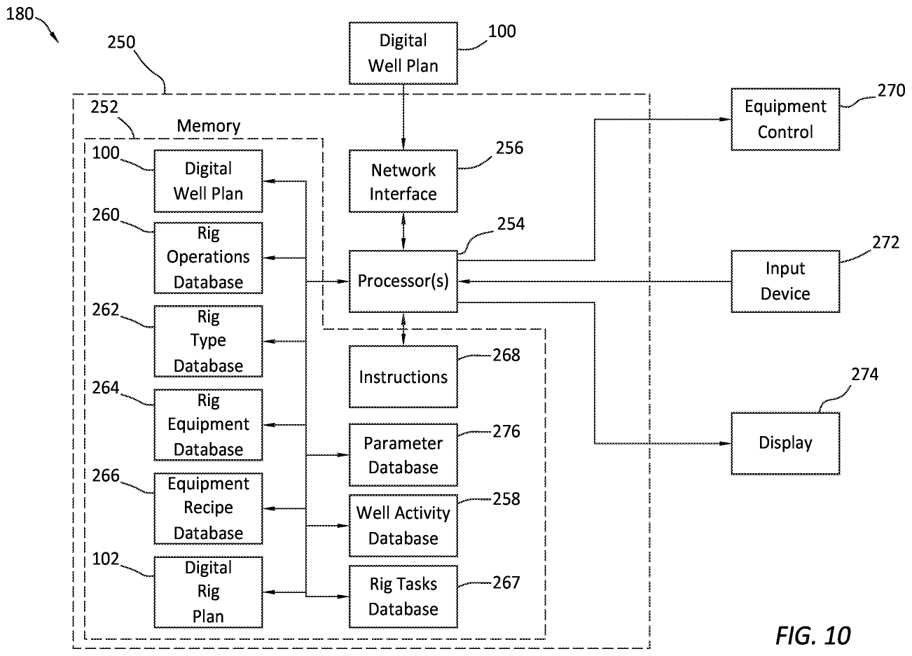

In operation 314, the rig controller 250 can determine a task that each one of the individuals 4 is executing or if the individual is idle (such as waiting to begin a task). By monitoring each individual 4 (via imaging system 240 or other sensors 74), the rig controller 250 can determine how well each individual performed or is performing a task of the rig plan 102. In operation 316, by comparing the performance of each individual 4 with an expected performance (which can be stored in the well activity database 258, see FIG. 10), the rig controller 250 can determine or update a proficiency score for each individual 4.

The proficiency scores for the individuals can be combined with proficiency scores for rig equipment to determine an overall activity proficiency score for the rig 10 for performing the digital well plan 100.

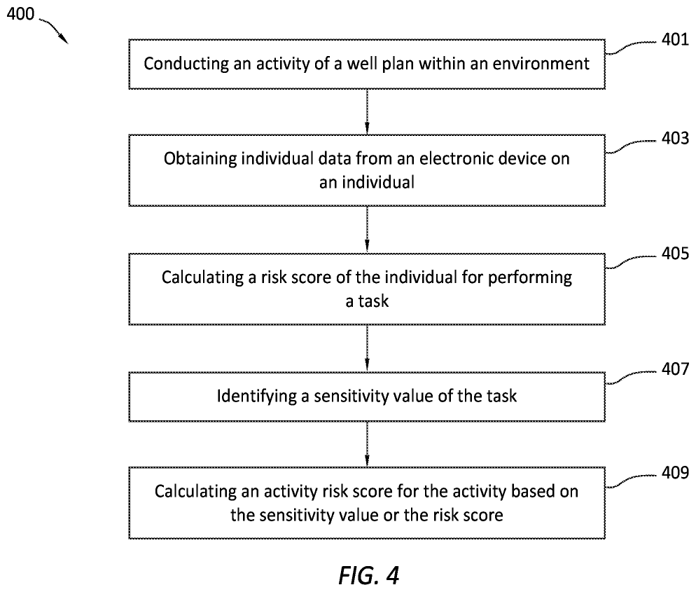

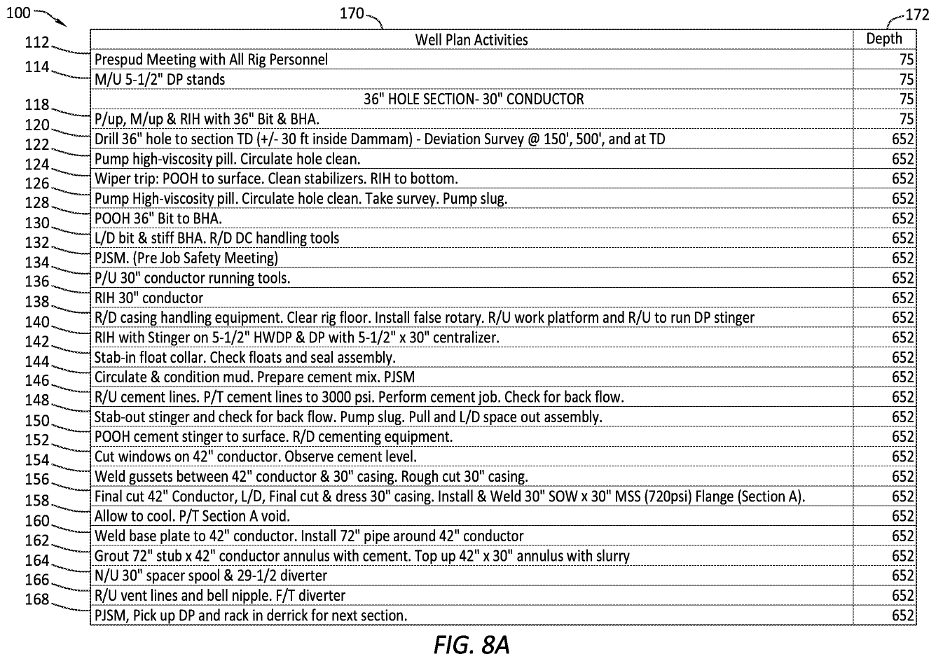

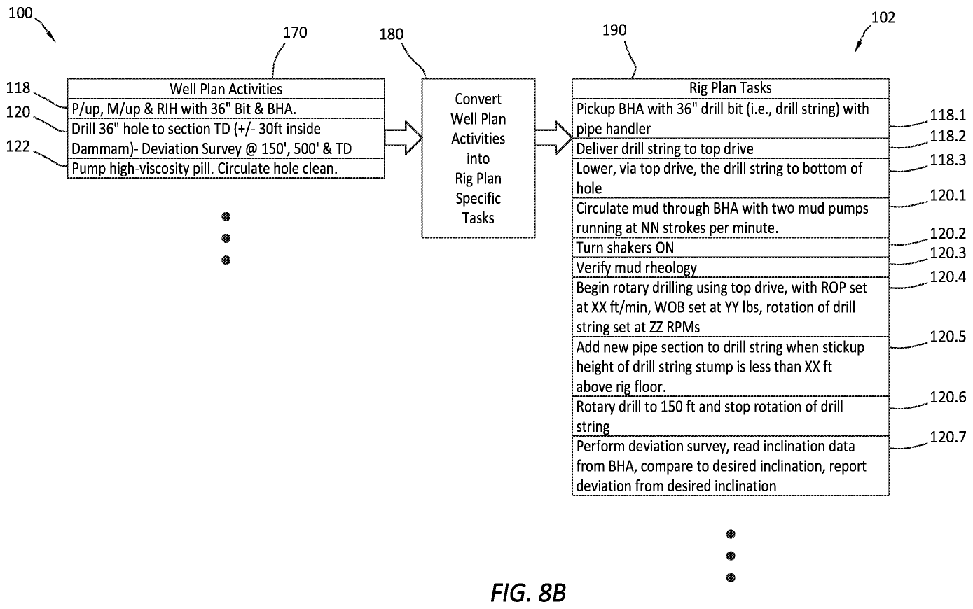

FIG. 4 is a representative flow diagram of a method 400 for calculating an activity risk score for a well activity of a digital well plan 100. Example well plan activities 170 are shown in FIGS. 8A and 8B. In a non-limiting embodiment, the method 400 can determine which of the well plan activities 170 of a digital well plan 100 (not limited by the example activities 170 in FIGS. 8A and 8B) is being performed or is to be performed on the rig 10 and determine an overall risk score for the well activity to indicate the probability of the rig 10 satisfactorily performing the well activity according to the digital well plan 100.

In operation 401, the rig 10, along with rig personnel (e.g., individuals 4), is conducting a subterranean operation within an environment, with the environment including at least a portion of the rig 10. In operation 403, an electronic device (e.g., a wearable 70) can be used to provide data to the rig controller 250 related to an individual performing a task at the rig site 11 (or on the rig 10). The task can be a primary task or a secondary task in support of executing the digital well plan 100 (or digital rig plan 102) at the rig site 11. In operation 405, the rig controller 250 can calculate a risk score for the individual who is planned to perform the task based at least in part on historical risk data associated with the individual for the task or similar task and the data received from the electronic device.

In operation 407, the rig controller 250 can determine a sensitivity value of the task. As used herein, the “sensitivity value” refers to a sensitivity to the execution of the digital rig plan 102 on the rig 10 based on execution of the task. In a non-limiting embodiment, the rig controller 250 can determine the sensitivity value from a lookup table stored in a database, where the database contains a plurality of sensitivity values, where the database can include information related to a rig plan for conducting a plurality of activities associated with a drilling operation, and each sensitivity value can be associated with at least one task of the digital rig plan 102. Higher sensitivity values indicate the execution of the digital rig plan 102 is more impacted by the performance of the task. Therefore, poor performance of the task creates a larger negative impact to the execution of the digital rig plan 102 than an impact for a task with a lower sensitivity value. Lower sensitivity values indicate the execution of the digital rig plan 102 is less impacted by the performance of the task.

The sensitivity value can be dependent upon whether the task is a primary task or a secondary task. For example, execution of secondary tasks generally causes less impact to the execution of the well activity than execution of primary tasks. Therefore, secondary tasks may generally have lower sensitivity scores than primary tasks. However, some primary tasks can have lower sensitivity scores than some secondary tasks. When the rig controller 250 determines the sensitivity value for the task, the rig controller 250 can retrieve a sensitivity value from a database or historical sensitivity data.

The sensitivity value can include an initial sensitivity value component which can be based at least in part upon historical sensitivity data or a designation of the task as a primary task or a secondary task, and a real-time sensitivity value component which can be based at least in part upon comparing a completion value of the activity performed or being performed to a completion value of the task performed or being performed. The completion value can be seen as a percentage of completion of the activity or task. If both completion values of the task and activity progress as expected based on the rig plan 102, then the sensitivity value may not need to be changed. However, if the completion values differ than what is expected based on the rig plan, the sensitivity value may need to change to more accurately represent the impact of the task execution on the execution of the activity.

The rig controller 250 can also simulate an execution of the digital rig plan 102 on the rig 10 to determine a sensitivity of the execution of the digital rig plan 102 to the execution of the task. The rig controller 250 can adjust the performance of the execution of the task and, via the simulation, determine how much the change in execution of the task impacts the execution of the activity. With the level of impact determined, the rig controller 250 can assign an appropriate sensitivity value. The simulation can be updated in real-time to include adjusted sensitivity values, proficiency scores, or risk scores.

In operation 409, the rig controller 250 can calculate a risk score for the well activity being conducted (or to be conducted) in the environment based on the risk score of the individual and the sensitivity value. The risk score indicates the probability the individual can satisfactorily perform the task. High risk scores indicate a high likelihood that the individual will not successfully complete the task as planned in the rig plan 102. Low risk scores indicate a high likelihood that the individual will successfully complete the task as planned in the rig plan 102 or even better than planned (i.e., exceeds performance expectations compared to the planned performance guidelines or budgets in the rig plan 102). Based on one or more sensitivity values and one or more individual risk scores, the rig controller 250 can determine an overall risk score for the activity which can indicate the probability that the activity will be satisfactorily performed. In a certain embodiment, the risk score for the well activity can be determined based on the risk score of the individual without using sensitivity value.

If the risk scores are high, then the digital rig plan 102 can be adapted to allocate more time for execution of tasks, provide more individuals or rig equipment to perform a task, or adapt the digital rig plan 102 to perform the activity of the well plan using different tasks, different individuals, or different rig equipment. Conversely, if the risk scores are low, then the digital rig plan 102 can be adapted to allocate less time for execution of tasks or provide fewer individuals or rig equipment to perform a task. The digital rig plan 102 can be adapted to assign individuals 4 or rig equipment to each task of the digital rig plan 102 based at least in part on the risk scores of the individuals and rig equipment.

The risk scores for the rig equipment can be used to indicate that future maintenance activities may be needed, that the equipment is performing as good or better than expected, or that the equipment has failed and needs to be repaired or replaced. The proficiency scores of the individuals can be used to indicate if one or more of the individuals 4 need additional training, are masters of the tasks performed, are working with outdated tools, or other performance metrics. The proficiency scores can be monitored over time to determine a risk score for each individual 4 to perform the task, which can be used to indicate a probability of whether or not the individual 4 will perform the task adequately in the future.

Calculating the risk score can include weighting factors, such as an individual's proficiency score (which can include the individual's experience level, familiarity with the rig, familiarity with the rig equipment, familiarity with the rig procedure, familiarity with the activity, level of training completed, etc.), environmental conditions, actual or perceived injuries, hours active, hours rested, risk scores of other individuals working with the individual, or combinations thereof. Therefore, a high risk score can indicate a high probability that the individual 4 may take longer to perform the task(s) than expected, may damage the equipment when performing the task(s), or even fail to perform the task(s) in the future. A low risk score can indicate a high probability that the individual 4 may perform the task(s) quicker than expected, perform the task(s) with discipline and efficiency, perform the task within the guidelines or budgets given in the rig plan 102, or be helpful to improve the efficiency of others.

The risk score can be stored in a database for later retrieval by the rig controller 250 when calculating other risk scores. The risk scores for individuals in a group can be used to determine an overall risk score for the group (e.g., group of 3rd party contractors, group of individuals working 1st, 2nd, or 3rd shifts, group of new hires fresh out of training, etc.). The group risk score can be adjusted over time as the risk scores for each of the individuals 4 that make up the group are monitored and adjusted.

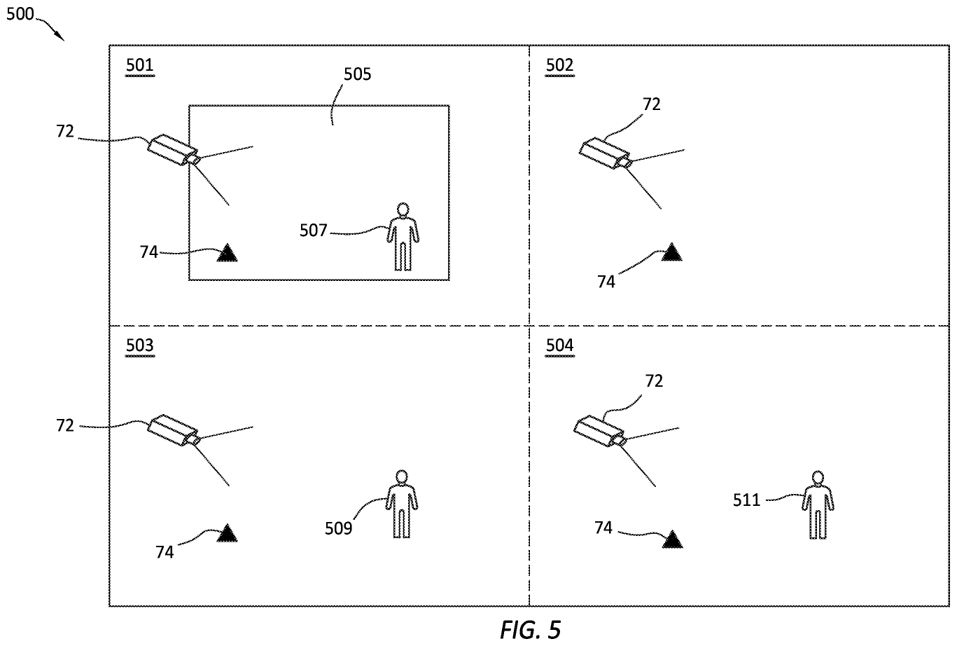

FIG. 5 is a representative block diagram of an environment 500 with multiple regions 501, 502, 503, 504 at a rig site 11. These regions can be different shapes as needed to organize access of individuals 4 to the regions 501, 502, 503, 504. Each region 501, 502, 503, 504 can include one or more imaging sensors 72 and one or more sensors 74. These sensors 72, 74 can capture sensor data (e.g., image data, acoustic data, proximity sensor data, thermal sensor data, vibration sensor data, RFID data, etc.) and communicate the sensor data to the rig controller 250, which can correlate the sensor data with the particular region 501, 502, 503, 504 from which the sensor data was collected. The regions 501, 502, 503, 504 can each be different than the other regions.

For example, region 501 can include a subregion 505. The subregion 505 (which can include the entire region 501), can be a red zone where drop hazards are possible and that individuals 4 (e.g., individual 507) should minimize their time within the red zone 505. This can be seen as the individual 507 entering the red zone 505, performing the needed task, and exiting the red zone 505 after completion of the task to minimize exposure of the individual 507 to the red zone 505. The sensors 72, 74, and the rig controller 250 can detect one or more individuals 4 in the subregion 505, determine the task(s) performed by the individuals 4 in the subregion 505 and log the task(s) which were performed as well as log the ability of the individual(s) to perform the task. This can be used to determine or modify a risk score or a proficiency score of the individuals 4 that performed the task(s).

Region 502 indicates that some of the regions 501, 502, 503, 504 may at times not have an individual 4 within them. The region 502 may, at some point in executing the digital well plan 100 (or digital rig plan 102) may have only rig equipment operating in it. The sensors 72, 74, and the rig controller 250 can be used to detect which of the rig equipment is being operated in the region 502 to perform a well activity.

Sensors 72, 74 in regions 503, 504 can detect individuals 4 in each of the regions as well as detecting the rig equipment operating in the regions 503, 504 to perform one or more well activities. The sensors 72, 74 in region 503 and the rig controller 250 can identify an individual 509 performing a task in support of a well activity with sensors 72, 74 in region 504 and the rig controller 250 that can identify an individual 511 (which can be different than the individual 509) performing another task in support of another well activity, or possibly in support of the same well activity that is being supported by region 503. The sensors 72, 74, along with the rig controller 250, can detect the individuals in each of the regions 501, 502, 503, 504 and determine the identity of each of the individuals 4 (e.g., 507, 509, 511), as well as determine the task that each individual 4 is performing. The rig controller 250 can also predict the task each individual 4 is to perform in any of the regions 501, 502, 503, 504 based on the digital rig plan 102.

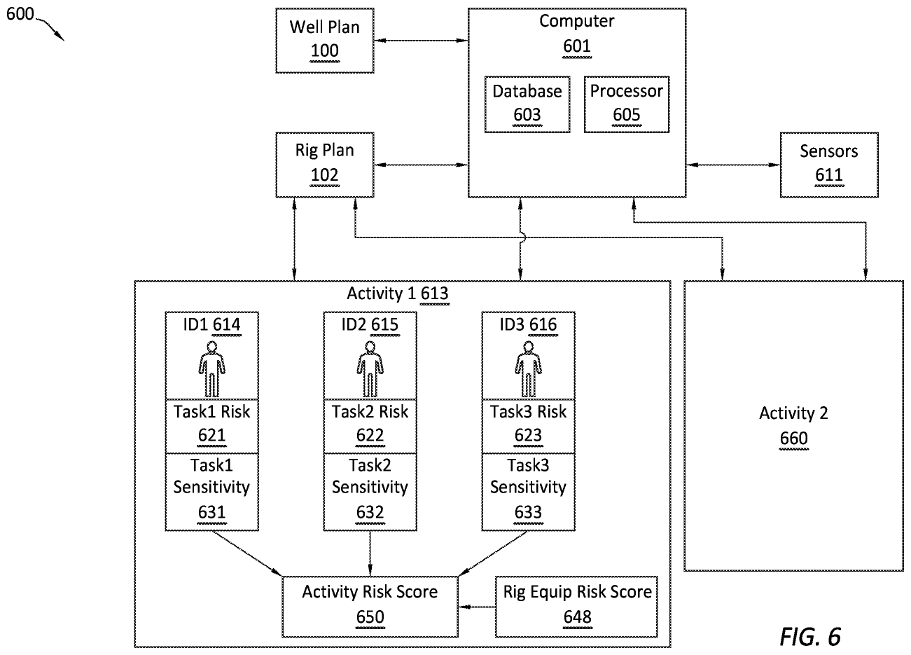

FIG. 6 is a functional block diagram of a method 600 using a computer 601 to determine risk scores 621, 622, 623, 648, 650 for various individuals, rig equipment, and activities 613, 660. The computer 601, as described in more detail below regarding FIGS. 8A, 8B, 10, can receive a digital well plan 100 and convert the digital well plan 100, via processor(s) 605 and one or more databases 603, into a rig specific digital rig plan 102 for executing the digital well plan 100 on the rig 10. The computer 601 can receive sensor data from sensors 611 (e.g., sensors 72, 74). The rig 10 can begin executing one or more well activities, such as activity 613 and activity 660. These can be serial activities which are executed one after another, or they can be parallel activities where at least a portion of the activity 660 is performed simultaneously with at least a portion of the activity 613.

Before the activity 613 is executed, the computer 601 can establish a risk score that is equivalent to an initial risk score component for the individuals, rig equipment, and activities 613, 660. The initial risk score component can be determined from historical risk data, calculated from current risk factors prior to execution of the tasks or activities, or determined through simulation of the rig plan 102 based on the current rig environment and current risk factors. The initial risk score component can be used to determine if there is a good probability that the tasks and activities will be performed according to the digital well plan 100 (or digital rig plan 102), or if modifications to the digital rig plan 102 may be needed to mitigate some or all of the risks indicated by the risk scores.

During execution of at least one of the activities 613, 660, the rig controller 250 can collect sensor data from the sensors 611 and use the sensor data to determine an estimated activity based on the sensor data and then compare the sensor data to reference data for an expected activity stored in a database to verify that the estimated activity is the actual activity being performed. The reference data can include historical data collected from previously completed activities. The reference data can include a list of rig tasks and associated sensor data that occurs for each of the rig tasks. Comparing the sensor data to the list of rig tasks and associated sensor data can be used to identify the actual activity being performed within the environment.

During execution of at least one of the activities 613, 660, the rig controller 250 can collect sensor data from the sensors 611 and use the sensor data to determine an estimated task for each individual based on the sensor data and then compare the sensor data to reference data stored in a database to verify that the estimated task is the actual task being performed. The reference data can include historical data collected from previously completed tasks. An actual task of the individual can include referencing a database with stored information related to the actual task of the individual, or sensing the actual task of the individual via one or more sensors monitoring the environment, or actively confirming the actual task of the individual with the individual via the electronic device; or combinations thereof. The identification of the actual task of the individual 4 can be confirmed by referencing a database having stored information related to the task of the individual, or sensing the task of the individual via one or more sensors in the environment, or actively confirming the task of the individual with the individual via the electronic device.

During execution of the activities 613, 660, the rig controller 250 can collect sensor data from the sensors 611 and use the sensor data to determine a real-time risk score component that can be used to modify the initial risk scores in real-time to determine a real-time risk score. The real-time risk score can indicate a real-time probability that the task or activity will be completed satisfactorily or if rig plan modifications are necessary to mitigate the risks to ensure satisfactory completion of the task or activity according to the digital well plan 100 (or digital rig plan 102).

The computer 601 can use the sensor data from various data sources to identify each of the individuals 4 (e.g., individuals 614, 615, 616) that may be assigned to perform a task or may be performing a task. The computer 601 can also determine the task to be performed or the task being performed by each individual based on either the digital rig plan 102, sensor data, or both. The computer 601 (or rig controller 250) can determine a risk score 621, 622, 623 for the task assigned to the respective individual 614, 615, 616. The risk score 621, 622, 623 can be determined by combining an initial individual risk score component with a real-time risk score component as described above.

The computer 601 (e.g., rig controller 250) can determine a sensitivity value 631, 632, 633 for the task assigned to the respective individual 614, 615, 616. The sensitivity value 631, 632, 633 can be determined, as described above, by simulating the rig plan 102 and determining the sensitivity of the execution of the activity 613, 660 to the execution of the assigned task. The sensitivity value 631, 632, 633 can also be determined, as described above, by selecting an entry in a lookup table that is associated with the task.

The computer 601 can determine a risk score 648 for the rig equipment that may be used for performing tasks of the activity 613, 660. The computer 601 can calculate an activity risk score 650 that incorporates the individual risk scores 621, 622, 623, possibly the sensitivity values 631, 632, 633, and the rig equipment risk score 648 (if used) into an overall risk score that can indicate the probability that the activity will be performed according to the digital well plan 100 (or digital rig plan 102). The risk scores can be calculated without using the sensitivity scores.

The who and where information of each individual 4 supporting the rig 10 can also be used to verify that the primary activities (or tasks) are being performed according to the digital well plan 100 (or digital rig plan 102) and that the secondary tasks are being performed in a timely manner so they do not become a primary activity. As used herein “primary activities” are those activities that are listed in the digital well plan, and the primary tasks are tasks that execute at least a portion of a well activity in the digital well plan. The secondary tasks provide support for execution of the primary activities/tasks. Secondary tasks can become primary tasks if they do not adequately support the primary activities and cause delays in the primary activities by not allowing proper execution of the primary activities.

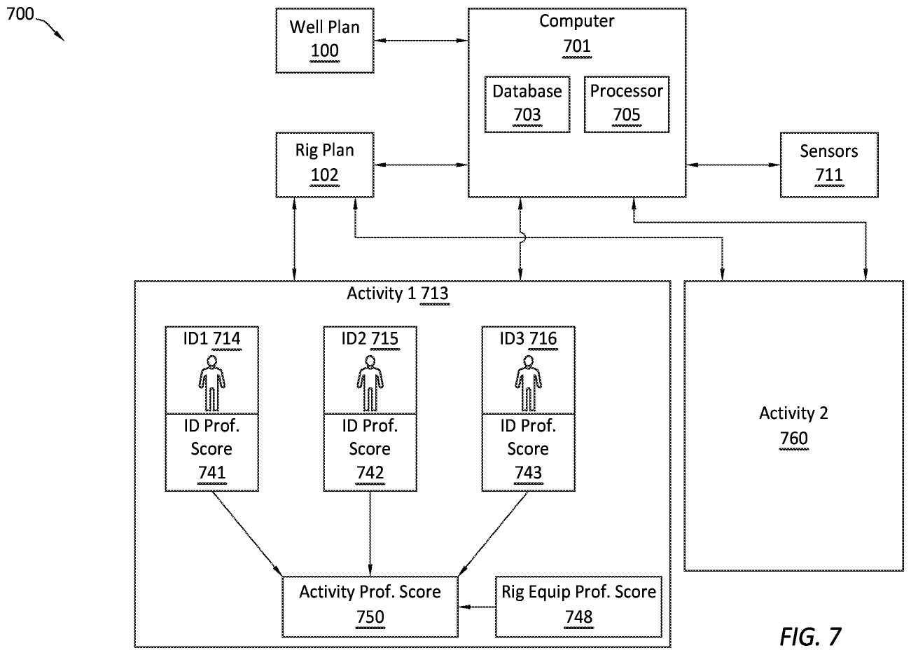

FIG. 7 is a functional block diagram of a method 700 using a computer 701 (or rig controller 250) to determine proficiency scores 741, 742, 743, 748, 750 for various individuals, rig equipment, and activities 713, 760. The computer 701 (e.g., the rig controller 250), as described in more detail below regarding FIGS. 8A, 8B, 10, can receive a digital well plan 100 and convert the digital well plan 100, via processor(s) 705 and one or more databases 703, into a rig specific digital rig plan 102 for executing the digital well plan 100 on the rig 10. The computer 701 can receive sensor data from sensors 711 (e.g., sensors 72, 74). The rig 10 can begin executing one or more well activities, such as activity 713 and activity 760. These can be serial activities that are executed one after another, or they can be parallel activities where at least a portion of the activity 760 is performed simultaneously with at least a portion of the activity 713.

The computer 701 can use the sensor data to determine the identity of each individual (such as individuals 714, 715, 716) assigned to perform a task during the activity 713. The computer 701 can determine a proficiency score 741, 742, 743 for each respective individual 714, 715, 716, and a proficiency score 748 for rig equipment used in performing the activity 713. The computer 701 can aggregate the proficiency scores 741, 742, 743, 748 to determine an overall proficiency score 750 for the activity 713. As stated above, the proficiency scores indicate the ability of competency for the individual or rig equipment to perform an assigned task. The computer 701 can also determine risk scores and proficiency scores for the activity 760, as well as any other activities in the well plan 100.

The rig controller 250 can compare the activity proficiency score to at least one historical activity proficiency score stored in a database and select at least one of the following processes, including 1) training the individual to improve an individual proficiency score, 2) updating a well plan including a list of activities to be completed, 3) updating a rig plan to change tasks associated with one or more individuals, 4) identifying an alternative pool of individuals to be used to complete the activity or a future activity, or 5) combinations thereof.

The rig controller 250 can also simulate the activity 713, 760 with at least one different individual to produce a simulated activity for the other individual, calculate a simulated activity proficiency score for the simulated activity using the other individual, compare the activity proficiency score to the simulated activity proficiency score, and evaluate whether to update a well plan or rig plan based on the comparison.

FIG. 8A is a representative list of well plan activities 170 for an example digital well plan 100. This list of well plan activities 170 can represent the activities needed to execute a full digital well plan 100. However, in FIG. 8A the list of activities 170 is merely representative of a subset of a complete list of activities needed to execute a full digital well plan 100 to drill and complete a wellbore 15 to a target depth (TD). The digital well plan 100 can include well plan activities 170 with corresponding wellbore depths 172. However, these activities 170 are not required for the digital well plan 100. More or fewer activities 170 can be included in the digital well plan 100 in keeping with the principles of this disclosure. Therefore, the following discussion relating to the well plan activities 170 is merely an example to illustrate the concepts of this disclosure. The well plan 100 can also define activities to be performed for other subterranean operations other than drilling, such as completion, treatment, production, abandonment, etc.

After the rig 10 has been utilized to drill the wellbore 15 to a depth of 75, at activity 112, a Prespud meeting can be held to brief all rig personnel on the goals of the digital well plan 100.

At activity 114, the appropriate personnel and rig equipment can be used to make-up (M/U) 5½″ drill pipe (DP) stands in prep for the upcoming drilling operation. This can, for example, require a pipe handler, horizontal or vertical storage areas for tubular segments, or tubular stands. The primary activities can be seen as the make-up of the drill pipe (DP) stands, with the secondary tasks being, for example, availability of tubular segments to build the DP stands; availability of a pipe handler (e.g., pipe handler 30) to manipulate the tubulars; a torquing wrench and backup tong for torquing joints when assembling the DP stands in a mousehole, a horizontal storage area, or a vertical storage area; available space in a storage area for the DP stands; doping compound and doping device available for cleaning and doping threads of the tubulars 50, and appropriate personnel to support these operations.

At activity 118, the appropriate personnel and rig equipment can be used to pick up (P/up), makeup (M/up), and run-in hole (RIH) a BHA with a 36″ drill bit 68. This can, for example, require BHA components; a pipe handler to assist in assembly of the BHA components; a pipe handler to deliver BHA to a top drive; and lowering the top drive to run the BHA into the wellbore 15. The primary activities can be seen as assembling the BHA and lowering the BHA into the well bore 15. The secondary tasks can be delivering the BHA components, including the drill bit, to the rig site; monitoring health of the equipment to be used; and ensuring personnel are available to perform tasks when needed.

At activity 120, the appropriate personnel and rig equipment can be used to drill 36″ hole to a TD of the section, such as 652 ft, to +/−30 ft inside a known formation layer (e.g., Dammam), and performing a deviation survey at depths of 150′, 500′ and TD (i.e., 652′ in this example). The primary activities can be seen as repeatedly feeding tubulars (or tubular stands 54) via a pipe handler to the well center from a tubular storage for connection to a tubular string 58 in the wellbore 15; operating the top drive 18, the iron roughneck 38, and slips to connect tubulars 50 (or tubular stands 54) to the tubular string 58; cleaning and doping threads of the tubulars 50, 54; running mud pumps to circulate mud through the tubular string 58 to the bit 68 and back up the annulus 17 to the surface; running shakers; injecting mud additives to condition the mud; rotating the tubular string 58 or a mud motor (not shown) to drive the drill bit 68, and performing deviation surveys at the desired depths.

The secondary tasks can be seen as having tubulars 50 (or tubular stands 54) available in the horizontal storage or vertical storage locations and accessible via the pipe handler. If coming from the horizontal storage 56, then the tubulars 50 can be positioned on horizontal stands, with individuals 4 operating handling equipment, such as forklifts 48 or crane 46, to keep the storage area 56 stocked with the tubulars 50. If coming from the vertical storage 36, then the rig personnel 4, can make sure that enough tubular stands 54 (or tubulars 50) are racked in the vertical storage 36 and accessible to the pipe handler 30 (or another pipe handler if needed). Additional secondary tasks can be seen as ensuring that the doping compound and doping device are available for cleaning and doping threads of the tubulars 50; mud additives are available for an individual 4 (e.g., mud engineer) or an automated process to condition the mud as needed; the top drive 18 (including drawworks), iron roughneck 38, slips, and pipe handlers are operational; and ensuring the power system 26 is configured to support the drilling operation.

At activity 122, the appropriate personnel and rig equipment can be used to pump a high-viscosity pill through the wellbore 15 via the tubular string 58 and then circulate wellbore 15 clean. The primary activities can be seen as injecting mud additives into the mud to create the high-viscosity pill, mud pumps operating to circulate the pill through the wellbore 15 (down through the tubular string 58 and up through the annulus 17); slips to hold tubular string 58 in place; top drive 18 connected to tubular string 58 to circulate mud; and, after pill is circulated, circulating mud through the wellbore 15 to clean the wellbore 15. The secondary tasks can be ensuring the power system 26 is configured to support the mud circulation activities; the mud pumps 84 are configured to supply the desired pressure and flow rate of fluid to the tubular string 58; and that the mud additives are available for an individual 4 (e.g., mud engineer) or an automated process to condition the mud as needed.

At activity 124, the appropriate personnel and rig equipment can be used to perform a “wiper trip” by pulling the tubular string 58 out of the hole (Pull out of hole—POOH) to the surface 6; clean stabilizers on the tubular string 58; and run the tubular string 58 back into the hole (Run in hole—RIH) to the bottom of the wellbore 15. The primary activities can be seen as operating the top drive 18, the iron roughneck 38, and slips to disconnect tubulars 50 (or tubular stands 54) from the tubular string 58; moving the tubulars 50 (or tubular stands 54) to vertical storage 36 or horizontal storage 56 via a pipe handler, equipment and personnel 4 to clean the stabilizers; and operating the top drive 18, the iron roughneck 38, and slips to again connect tubulars 50 (or tubular stands 54) to the tubular string 58; and run the tubular string 58 back into the wellbore 15.

The secondary tasks can be seen as having the top drive 18 (including drawworks), iron roughneck 38, slips, and pipe handlers operational; ensuring the power system 26 is configured to support the tripping out and tripping in operations; and ensuring that the appropriate individual(s) 4 and cleaning equipment are available to perform stabilizer cleaning when needed.

At activities 126 thru 168, the appropriate personnel and rig equipment can be used to perform the indicated well plan activities. The primary activities can include the personnel, equipment, or materials needed to directly execute the well plan activities using the specific rig 10. The secondary tasks can be those activities that ensure the personnel, equipment, or materials are available and configured to support the primary activities.

FIG. 8B is a functional diagram that can illustrate conversion of well plan activities 170 to rig plan tasks 190 of a rig specific digital rig plan 102. When a well plan 100 is designed, well plan activities 170 can be included to describe primary activities needed to construct a desired wellbore 15 to a TD. However, the well plan 100 activities 170 are not specific to a particular rig, such as rig 10. It may not be appropriate to use the well plan activities 170 to direct specific operations on a specific rig, such as rig 10. Therefore, a conversion of the well plan activities 170 can be performed to create a list of rig plan tasks 190 of a digital rig plan 102 to construct the desired wellbore 15 using a specific rig, such as rig 10. This conversion engine 180 (which can run on a computing system such as the rig controller 250) can take the non-rig specific well plan activities 170 as an input and convert each of the non-rig specific well plan activities 170 to one or more rig specific tasks 190 to create a digital rig plan 102 that can be used to direct tasks on a specific rig, such as rig 10, to construct the desired wellbore 15.

As way of example, a high-level description of the conversion engine 180 will be described for a subset of well plan activities 170 to demonstrate a conversion process to create the digital rig plan 102. The well plan activity 118 states, in abbreviated form, to pick up, make up, and run-in hole a BHA 60 with a 36″ drill bit. The conversion engine 180 can convert this single non-rig specific activity 118 into, for example, three rig-specific tasks 118.1, 118.2, 118.3. Task 118.1 can instruct the rig operators or rig controller 250 to pickup the BHA 60 (which has been outfitted with a 36″ drill bit) with a pipe handler. At task 118.2, the pipe handler can carry the BHA 60 and deliver it to the top drive 18, with the top drive 18 using an elevator to grasp and lift the BHA 60 into a vertical position. At task 118.3, the top drive 18 can lower the BHA 60 into the wellbore 15 which has already been drilled to a depth of 75′ for this example as seen in FIG. 4A. The top drive 18 can lower the BHA 60 to the bottom of the wellbore 15 to have the drill bit 68 in position to begin drilling as indicated in the following well activity 120.

The well plan activity 120 states, in abbreviated form, to drill a 36″ hole to a target depth (TD) of the section, such as 652 ft, to +/−30 ft inside a known formation layer (e.g., Dammam), and performing a deviation survey at depths of 150′, 500′ and TD (i.e., 652′ in this example). The conversion engine 180 can convert this single non-rig specific activity 120 into, for example, seven rig-specific tasks 120.1 to 120.7. Task 120.1 can instruct the rig operators or rig controller 250 to circulate mud through the top drive 18, through the drill string 58, through the BHA 60, and exiting the drill string 58 through the drill bit 68 into the annulus 17. For this example, the mud flow requires two mud pumps 84 to operate at “NN” strokes per minute, where “NN” is a desired value that delivers the desired mud flow and pressure. At task 120.2, the shaker tables can be turned on in preparation for cuttings that should be coming out of the annulus 17 when the drilling begins. At task 120.3, a mud engineer can verify that the mud characteristics are appropriate for the current tasks of drilling the wellbore 15. If the rheology indicates that mud characteristics should be adjusted, then additives can be added to adjust the mud characteristics as needed.

At task 120.4, rotary drilling can begin by lowering the drill bit into contact with the bottom of the wellbore 15, and rotating the drill bit by rotating the top drive 18 (e.g., rotary drilling). The drilling parameters can be set to be “XX” ft/min for rate of penetration (ROP), “YY” lbs for weight on bit (WOB), and “ZZ” revolutions per minute (RPM) of the drill bit 68.

At task 120.5, as the wellbore 15 is extended by the rotary drilling when the top end of the tubular string 58 is less than “XX” ft above the rig floor 16, then a new tubular segment (e.g., tubular, tubular stand, etc.) can be added to the tubular string 58 by retrieving a tubular segment 50, 54 from tubular storage via a pipe handler, stop mud flow and disconnect the top drive from the tubular string 58, hold the tubular string 58 in place via the slips at well center, raise the top drive 18 to provide clearance for the tubular segment to be added, transfer tubular segment 50, 54 from the pipe handler 30 to the top drive 18, connect the tubular segment 50, 54 to the top drive 18, lower the tubular segment 50, 54 to the stump of the tubular string 58 and connect it to the tubular string 58 using a roughneck to torque the connection, then start mud flow. This can be performed each time the top end of the tubular string 58 is lowered below “XX” ft above the rig floor 16.

At task 120.6, add tubular segments 50, 54 to the tubular string 58 as needed in task 120.5 to drill wellbore 15 to a depth of 150 ft. Stop rotation of the drill bit 68 and stop mud pumps 84.

At task 120.7, perform a deviation survey by reading the inclination data from the BHA 60, comparing the inclination data to expected inclination data, and report deviations from the expected. Correct drilling parameters if deviations greater than a pre-determined limit.

The conversion from a well plan 100 to a rig-specific rig plan 102 can be performed manually or automatically with the best practices and equipment recipes known for the rig that are to be used in the wellbore construction.

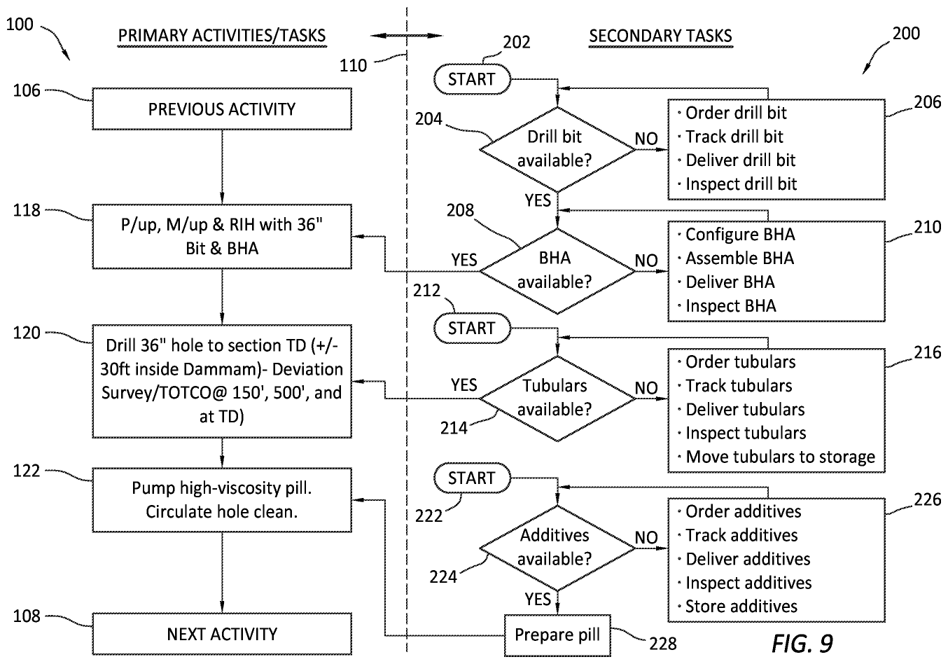

FIG. 9 is a flow diagram that shows secondary tasks occurring at the same time, or at least a portion in parallel, with primary activities, where the secondary tasks can be tasks that support the execution of the primary activities, and where the primary activities can be activities in a digital well plan 100. Delays in execution of the primary activities can have a direct impact on completion of the well plan in the desired amount of time. Secondary tasks should not directly impact the completion of the well plan unless they cause delays in the primary activities. If a secondary task directly impacts a primary activity, then the secondary task can become a primary activity, since its completion may directly impact well plan completion deadlines.

FIG. 9 shows primary activities/tasks that can be executed in sequence as the well plan is executed on the rig 10. After completion of a previous activity 106, the rig can proceed to the activity 118. The appropriate personnel and rig equipment can be used to pick up (P/up), makeup (M/up) and run-in hole (RIH) a BHA with a 36″ drill bit 68. However, there can be secondary tasks 200 that may need to be performed simultaneously with the previous activity 106 or before the previous activity 106 such that the activity 118 can be performed without delay when the previous activity 106 (for example, activity 114 for making up 5½″ DP stands) is completed.

The secondary tasks 200 are shown on the right side of the primary/secondary dividing line 110 that symbolically separates the primary activities (shown on the left of the line 110) from the secondary tasks. This separation can be maintained as long as the secondary tasks do not become primary activities by delaying execution of a primary activity by a delayed completion of the secondary task.

Regarding the primary activity 118, the BHA components should be available well before they are needed in the primary activity 118. Therefore, secondary tasks (e.g., operations 202, 204, 206, 208, 210) should be performed in parallel or prior to the previous activity 106 so that when the previous activity 106 is complete and it is time to execute the activity 118, the BHA 60 is ready to be run-in the hole. Therefore, as way of example, the secondary tasks to prepare the BHA 60 for activity 118, in which it is to be used, can start the secondary tasks at the operation 202. At operation 204, it is determined whether the desired drill bit 68 (e.g., 36″ drill bit in this example) is available for assembly onto the BHA drill collars, if not, an appropriate drill bit can be ordered, shipment tracked, delivered to the rig or rig site, and inspected at operation 206. Operation 206 can deliver the newly acquired drill bit 68 to a BHA assembly area for attachment to the BHA drill collars. With the drill bit available, the secondary tasks can proceed to operation 208 to determine if the BHA is available for use in the activity 118. If not, then operation 210 can be performed to assemble the BHA components together, inspect the BHA and deliver the BHA to a BHA storage area. When the rig is ready to execute the activity 118, then a pipe hander 30 can deliver the BHA to well center, hand it off to the top drive 18, which can then lower the BHA into the wellbore 15.

If the secondary tasks are not performed in time to have the BHA available when the activity 118 begins, then the secondary tasks can be directly impacting execution times of the primary activities and thereby become primary activities themselves.

Similarly, after completion of the activity 118, the rig can proceed to the activity 120. The appropriate personnel and rig equipment can be used to drill 36″ hole to a TD of the section, such as 652 ft, to +/−30 ft inside a known formation layer (e.g., Dammam), and performing a deviation survey at depths of 150′, 500′ and TD (i.e., 652′ in this example). However, there can be secondary tasks 200 that may need to be performed simultaneously with the activity 118 or before the activity 118 such that the activity 120 can be performed without delay when the activity 118 is complete.

Regarding activity 120, the primary activities can be seen as repeatedly feeding tubulars (or tubular stands 54) via a pipe handler 30 from a tubular storage for connection to a tubular string 58 to the well center; operating the top drive 18, the iron roughneck 38, and slips to connect tubulars 50 (or tubular stands 54) to the tubular string 58; cleaning and doping threads of the tubulars 50, 54; running mud pumps to circulate mud through the tubular string 58 to the bit 68 and back up the annulus 17 to the surface; running shakers; injecting mud additives to condition the mud; rotating the tubular string 58 or a mud motor (not shown) to drive the drill bit 68, and performing deviation surveys at the desired depths.

The secondary tasks 200 can be seen as having tubulars 50 (or tubular stands 54) available in the horizontal storage or vertical storage locations and accessible via the pipe handler 30. If coming from the horizontal storage 56, then the tubulars 50 can be positioned on horizontal stands, with individuals 4 operating handling equipment, such as forklifts 48 or crane 46, to keep the storage area 56 stocked with the tubulars 50. If coming from the vertical storage 36, then the rig personnel 4, can make sure that enough tubular stands 54 (or tubulars 50) are racked in the vertical storage 36 and accessible to the pipe handler 30 (or another pipe handler if needed). Additional secondary tasks can be seen as ensuring that the doping compound and doping device are available for cleaning and doping threads of the tubulars 50; mud additives are available for an individual 4 (e.g., mud engineer) or an automated process to condition the mud as needed; the top drive 18 (including drawworks), iron roughneck 38, slips, and pipe handlers are operational; and ensuring the power system 26 is configured to support the drilling operation.

As way of example, as shown in FIG. 9, some secondary tasks can be to have the necessary tubulars 50, 54 available in a storage area accessible by the top drive or pipe handler so execution of the primary activity 120 can begin as soon as the activity 118 is completed. The secondary tasks 212, 214, 216 for providing tubulars for activity 120 can start at the operation 212. At operation 214, it can be determined whether the tubulars 50, 54 are available for extending the tubular string 58 into the wellbore 15 as activity 120 progresses to completion. If not available, or not enough available, appropriate tubulars can be ordered, shipment tracked, delivered to the rig or rig site, inspected, and moved to storage areas accessible to the top drive 18 or pipe handler 30 at operation 216.

If tubular stands 54 are needed, then the secondary tasks 200 can include an operation of building tubular stands 54 from the tubulars 50. In this particular example, the secondary tasks 212, 214, 216 can be performed simultaneously while the primary activity 120 is being performed. The secondary tasks 212, 214, 216 need only provide enough tubulars 50, 54 to the tubular storage areas to support when the rig requires the next tubular 50, 54 to be added to the tubular string 58. Therefore, tubulars 50, 54 can be delivered to the storage areas during the time the tubulars are being removed from the storage area to be added to the tubular string 58. The secondary tasks 200 do not become primary activities until the top drive 18 or pipe hander 30 cannot retrieve a tubular 50, 54 from the storage to continue the primary activity 120. However, the tubulars 50, 54 can also be delivered and installed in the storage area prior to the beginning of the activity 120.

Another secondary task that can occur pertains to replacing damaged or otherwise unusable tubulars 50, 54 with useable tubulars 50, 54 before the rig runs out of available tubulars 50, 54 to support the activity 120.

In operation 216, the imaging system 240 or other sensors 74 can be used to inspect and possibly identify at least one characteristic of at least one of the tubulars being provided for the primary activity 118, which be an activity in extending a drill string into the wellbore 15. The characteristic can be a total length of a tubular, a diameter of a tubular, or a combination thereof. If the inspection identifies that the at least one characteristic of the at least one of the tubulars is outside of an inspection criterion for the characteristic, (e.g., too long, too short, bent causing varied diameter along the tubular, etc.), then the rig controller 250 can initiate a tubular replacement procedure that causes the non-compliant tubular(s) to be removed from the tubular storage and replaced by tubulars that are compliant with the inspection criteria.

At primary activity 122, the appropriate personnel and rig equipment can be used to pump a high-viscosity pill through the wellbore 15 via the tubular string 58 and then circulate wellbore 15 clean. The primary activities can be seen as injecting mud additives into the mud to create the high-viscosity pill, mud pumps operating to circulate the pill through the wellbore 15 (down through the tubular string 58 and up through the annulus 17); slips to hold tubular string 58 in place; top drive 18 connected to tubular string 58 to circulate mud; and, after pill is circulated, circulating mud through the wellbore 15 to clean the wellbore 15.

The secondary tasks 200 can ensure the power system 26 is configured to support the mud circulation activities; the mud pumps 84 are configured to supply the desired pressure and flow rate of fluid to the tubular string 58; and that the mud additives are available for an individual 4 (e.g., mud engineer) or an automated process to condition the mud as needed.

As way of example, as shown in FIG. 9, some secondary tasks 200 can be to have the necessary additives available and accessible to a mud engineer to condition the mud as needed to prepare the pill at operation 228 prior to completion of the primary activity 120 so execution of the primary activity 122 can begin on time. The secondary tasks 222, 224, 226, 228 for providing the additives and preparing the pill can start at the operation 222. At operation 224, it can be determined whether the additives are available for conditioning the mud. If not available, additives can be ordered, shipment tracked, delivered to the rig or rig site, inspected, and moved to storage for access by the mud engineer or automated process to prepare the pill in operations 228.

It should be understood that these secondary tasks 200 can be a subset of the available secondary tasks. Many more secondary tasks can be required to support the primary activities throughout the execution of the well plan 100 on the rig 10. However, the secondary tasks 200 described here can illustrate the interaction between primary activities and secondary tasks for executing a well plan 100.

The data sources available to the rig controller 250 can be used to monitor and verify if the secondary tasks 200 are being performed in a timely manner to support the particular primary activities 170. Therefore, if the rig controller 250 identifies a secondary task 200 that is not being completed in time to support upcoming primary activities 170, the rig controller 250 can alert an appropriate individual 4 (e.g., driller, roughneck, operator, company man, mud engineer, etc.) to implement corrective actions to get the appropriate secondary tasks 200 completed in time to support the primary activities 170. The rig controller 250 can also act autonomously to initiate corrective actions to correct execution of the secondary tasks 200 to minimize or prevent the secondary tasks 200 from impacting execution of the primary activities 170. For example, the rig controller 250 can initiate expedited orders of material to be delivered, turn on other equipment if current equipment is not functioning or otherwise not available, request additional personnel to assist in execution of the operations 200, etc.

The rig controller 250 can monitor the secondary tasks 200 and automatically create and communicate periodic reports to individual(s) 4 or other controllers to inform the individuals or other controllers of the status of the secondary tasks 200, and highlight areas of concern related to the timely execution of the secondary tasks 200 and identify any of the secondary tasks 200 that may impact execution of the primary activities 170. The rig controller 250 can analyze the secondary tasks 200 being performed at the rig site and compare them to the digital well plan 100. If more or fewer secondary tasks 200 are being performed than indicated by the digital rig plan 102 that is implementing the digital well plan 100, then the rig controller 250 can alert individuals 4 to the mismatch and initiate corrective actions (either automatically, semi-automatically after requesting and receiving user input, or manually via user input) based on the mismatch identified during the comparing.

FIG. 10 is a representative functional block diagram of the rig plan engine 180 that can include possible databases used by a rig controller 250 to convert a digital well plan 100 to a digital rig plan 102, for identifying individuals detected in work zones on the rig 10, for storing and providing sensitivity values, storing, and providing historical risk data, and storing and providing historical proficiency data. The rig plan engine 180 can be a program (i.e., list of instructions 268) that can be stored in the non-transitory memory 252 and executed by processor(s) 254 of the rig controller 250 to convert a digital well plan 100 to a digital rig plan 102 or identify individuals 4 on the rig 10.

A digital well plan 100 can be received at an input to the rig controller 250 via a network interface 256. The digital well plan 100 can be received by the processor(s) 254 and stored in the memory 252. The processor(s) 254 can then begin reading the sequential list of well plan activities 170 of the digital well plan 100 from the memory 252. The processor(s) 254 can process each well plan activity 170 to create rig-specific tasks to implement the respective activity 170 on a specific rig (e.g., rig 10).

To convert each well plan activity 170 to rig-specific tasks for a rig 10, processor(s) 254 must determine the equipment available on the rig 10, the best practices, operations, and parameters for running each piece of equipment, and the operations to be run on the rig to implement each of the well plan activities 170.

Referring again to FIG. 10, the processor(s) 254 are communicatively coupled to the non-transitory memory 252 which can store multiple databases for converting the well plan 100 into the rig plan 102 and for identifying individuals detected in work zones on the rig 10. A rig operations database 260 includes rig operations for implementing each of the well plan activities 170. Each of the rig operations can include one or more tasks to perform the rig operation. The processor(s) 254 can retrieve those operations for implementing the first rig activity 170 from the rig operations database 260 including the task lists for each operation. The processor(s) 254 can receive a rig type RT from a user input or the network interface 256. With the rig type RT, the processor(s) 254 can retrieve a list of equipment available on the rig 10 from the rig type database 262, which can contain equipment lists for a plurality of rig types.

The processor(s) 254 can then convert the operation tasks to rig specific tasks to implement the operations on the rig 10. The rig specific tasks can include the appropriate equipment for rig 10 to perform the operation task. The processor(s) 254 can then collect the recipes for operating each of the available equipment for rig 10 from the recipes database 266, where the recipes can include best practices on operating the equipment, preferred parameters for operating the equipment, and operational tasks for the equipment (such as turn ON procedures, ramp up procedures, ramp down procedures, shutdown procedures, etc.).

Therefore, the processor(s) 254 can retrieve each of the well plan activities 170 and convert them to a list of rig specific tasks that can perform the respective well plan activity 170 on the rig 10. After converting all of the well plan activities 170 to rig specific tasks 190 and creating a sequential list of the tasks 190, the processor(s) 254 can store the resulting digital rig plan 102 in the memory 252. When the rig 10 is operational and positioned at the proper location to drill a wellbore 15, the rig controller 250, via the processor(s) 254, can begin executing the list of tasks in the digital rig plan 102 by sending control signals and messages to the equipment control 270.

The rig controller 250 can also receive user input from an input device 272 or display information to a user or individual 4 via a display 274. The input device 272 in cooperation with the display 274 can be used to input well plan activities, initiate processes (such as converting the digital well plan 100 to the digital rig plan 102), select alternative activities, or rig tasks during execution of digital well plan 100 or digital rig plan 102, or monitor operations during well plan execution. The input device 272 can also include the sensors 74 and the imaging sensors 72, which can provide sensor data (e.g., image data, temperature sensor data, pressure sensor data, operational parameter sensor data, etc.) to the rig controller 250 for determining the actual well activity of the rig.

### VARIOUS EMBODIMENTS

Embodiment 1. A method for conducting operations in an environment comprising:
conducting an activity of a well plan within an environment;
obtaining individual data from an electronic device on an individual;
calculating an individual risk score of the individual for performing a task in support of the activity;
identifying a sensitivity value of the task; and
calculating an activity risk score for the activity based at least in part on the individual risk score and sensitivity value.

Embodiment 2. The method of embodiment 1, wherein conducting the activity within the environment comprises conducting a subterranean operation.

Embodiment 3. The method of embodiment 1, wherein conducting the activity comprises conducting an activity on a rig.

Embodiment 4. The method of embodiment 3, wherein conducting the activity comprises conducting a task.

Embodiment 5. The method of embodiment 4, wherein the task of the individual is categorized as a primary task or secondary task.

Embodiment 6. The method of embodiment 4, wherein the task of the individual is categorized as a primary task or secondary task and stored in a database, and wherein the sensitivity value of the task is based at least in part upon the task being a primary task or a secondary task.

Embodiment 7. The method of embodiment 4, wherein conducting the activity comprises:
determining an actual well activity occurring on the rig;
identifying one or more secondary tasks that are occurring simultaneously with one or more primary tasks;
comparing, via a rig controller, the secondary tasks to a rig plan; and
based on the comparing, determining whether the secondary tasks are occurring at a proper time to support the one or more primary tasks or future primary tasks.

Embodiment 8. The method of embodiment 7, wherein the actual well activity requires running a drill string into a wellbore.

Embodiment 9. The method of embodiment 8, wherein the primary tasks for the actual well activity comprise using a pipe handler for retrieving tubulars from a storage area, using a top drive for receiving the tubulars from the pipe handler, repeatedly connecting individual tubulars to an upper end of the drill string, thereby extending the drill string into the wellbore.

Embodiment 10. The method of embodiment 9, wherein the secondary tasks comprise: verifying at least one characteristic of at least one of the individual tubulars needed to support the extension of the drill string into the wellbore.

Embodiment 11. The method of embodiment 10, wherein the at least one characteristic includes a total length of a tubular, a diameter of a tubular, or a combination thereof.

Embodiment 12. The method of embodiment 10, further comprising requesting, via the rig controller, additional tubulars be added if the at least one characteristic is not sufficient to support the running of the drill string.

Embodiment 13. The method of embodiment 1, wherein the electronic device is worn by the individual.

Embodiment 14. The method of embodiment 1, wherein the electronic device includes a unique identification number associated with the individual.

Embodiment 15. The method of embodiment 14, wherein the unique identification number is detectable by one or more active or passive detection systems in the environment.

Embodiment 16. The method of embodiment 1, wherein the environment includes one or more electronic devices configured to communicate with the electronic device on the individual and track movements and actions of the individual in the environment.

Embodiment 17. The method of embodiment 1, wherein the electronic device is configured to monitor one or more health signals from the individual to calculate the individual risk score of the individual for performing the task.

Embodiment 18. The method of embodiment 1, wherein the electronic device comprises a display configured to display a communication to the individual, wherein such communication includes an alert, a change to the activity, a change to the task, a status of the activity, the individual risk score, the sensitivity value, the activity risk score, an individual proficiency score, an activity proficiency score, or any combination thereof.

Embodiment 19. The method of embodiment 1, wherein individual data is gathered from the electronic device on the individual and one or more remote sensors observing the individual.

Embodiment 20. The method of embodiment 19, wherein calculating the individual risk score is based on the individual data gathered from the electronic device and data from one or more remote sensors observing the individual.

Embodiment 21. The method of embodiment 1, wherein the individual risk score includes an initial individual risk score component based at least in part upon historical risk data associated with the individual for an assigned task.

Embodiment 22. The method of embodiment 1, wherein the individual risk score includes a real-time individual risk score component based at least in part upon comparing an expected characteristic of the individual to an actual characteristic of the individual.

Embodiment 23. The method of embodiment 22, wherein the expected characteristic of the individual includes at least one of an expected position of the individual within the environment, an expected movement of the individual within the environment, an expected movement of one or more body parts of the individual within the environment, an expected health signal of the individual, expected conditions within the environment, or any combination thereof.

Embodiment 24. The method of embodiment 23, wherein the expected characteristic is stored in a database.

Embodiment 25. The method of embodiment 23, wherein the expected characteristic is a value stored in a database and the value is based upon historical data of the individual.

Embodiment 26. The method of embodiment 22, wherein the actual characteristic of the individual includes at least one of an actual position of the individual within the environment, an actual movement of the individual within the environment, an actual movement of one or more body parts of the individual within the environment, an actual health signal of the individual, actual conditions within the environment or any combination thereof.

Embodiment 27. The method of embodiment 26, wherein the actual characteristic is measured in real-time based upon the individual data from the electronic device on the individual, data associated with the individual, the data being obtained from one or more sensors in the environment, or a combination thereof.

Embodiment 28. The method of embodiment 1, wherein calculating the individual risk score includes using historical risk data associated with the individual for the task.

Embodiment 29. The method of embodiment 1, wherein calculating the individual risk score is completed by a machine learning program using historical risk data for the individual.

Embodiment 30. The method of embodiment 1, wherein calculating the individual risk score comprises:
assigning an initial individual risk score component to an individual for the task, wherein the initial individual risk score component is based at least in part upon historical risk data associated with the individual for the task or for a similar task; and
calculating a real-time individual risk score by updating the initial individual risk score component with a real-time individual risk score component, wherein calculating the real-time individual risk score is based at least in part upon comparing an expected characteristic of the individual to an actual characteristic of the individual.

Embodiment 31. The method of embodiment 30, further comprising sending the real-time individual risk score to the electronic device on the individual or storing the real-time individual risk score in one or more databases.

Embodiment 32. The method of embodiment 30, further comprising adapting the task based upon the real-time individual risk score.

Embodiment 33. The method of embodiment 30, further comprising calculating an updated activity risk score for the activity based at least in part on the real-time individual risk score.

Embodiment 34. The method of embodiment 33, further comprising sending the updated activity risk score to one or more individuals or storing the updated activity risk score in one or more databases.

Embodiment 35. The method of embodiment 1, further comprising:
identifying an actual task of the individual by comparing an expected task of the individual to an estimated task of the individual.

Embodiment 36. The method of embodiment 1, further comprising:
identifying an actual task of the individual by at least one of:
i) referencing a database having stored information related to the actual task of the individual;
ii) sensing the actual task of the individual via one or more sensors in the environment;
iii) actively confirming the actual task of the individual with the individual via the electronic device; or
iv) combinations thereof.

Embodiment 37. The method of embodiment 36, wherein identifying the actual task of the individual includes confirming the actual task of the individual by conducting at least two or more of:
i) referencing a database having stored information related to the task of the individual;
ii) sensing the task of the individual via one or more sensors in the environment; and
iii) actively confirming the task of the individual with the individual via the electronic device.

Embodiment 38. The method of embodiment 1, wherein the sensitivity value of the task is based at least in part upon designation of the task as a primary task or a secondary task.

Embodiment 39. The method of embodiment 1, wherein the sensitivity value is a predetermined value stored in a database.

Embodiment 40. The method of embodiment 1, wherein the sensitivity value is obtained from a database including a plurality of sensitivity values, wherein each of the sensitivity values are associated with an actual task.

Embodiment 41. The method of embodiment 1, wherein the sensitivity value is one of a plurality of sensitivity values stored in a database that also includes information related to a rig plan for conducting a plurality of activities associated with a drilling operation, and wherein each sensitivity value is associated with at least one activity in the rig plan.

Embodiment 42. The method of embodiment 1, wherein the sensitivity value comprises:
an initial sensitivity value component based at least in part upon designation of the task as a primary task or a secondary task; and
a real-time sensitivity value component based at least in part upon comparing a completion value of the activity to a completion value of the task.

Embodiment 43. The method of embodiment 1, wherein the sensitivity value is configured to be adapted in real time via an algorithm based at least in part upon comparing a completion value of the activity to a completion value of the task.

Embodiment 44. The method of embodiment 1, wherein calculating an activity proficiency score includes calculating an individual proficiency score for the individual, wherein the activity proficiency score indicates a level of performance of a rig and one or more individuals to perform the activity, and wherein the individual proficiency score indicates a level of performance of the individual to perform the task.

Embodiment 45. The method of embodiment 44, further comprising storing the individual proficiency score in a database and aggregating individual proficiency scores over time to evaluate performance of the individual.

Embodiment 46. The method of embodiment 44, wherein the activity proficiency score is based at least in part upon at least one individual proficiency score.

Embodiment 47. The method of embodiment 44, further comprising adapting future activities based upon the activity proficiency score.

Embodiment 48. The method of embodiment 44, further comprising comparing the activity proficiency score to at least one historical activity proficiency score and selecting at least one process from the following:
i) training the individual to improve an individual proficiency score;
ii) updating a well plan including a list of activities to be completed;
iii) updating a rig plan to change tasks associated with one or more individuals;
iv) identifying an alternative pool of individuals to be used to complete the activity or a future activity; or
v) combinations thereof.

Embodiment 49. The method of embodiment 44, further comprising:
i) simulating the activity with at least one different individual to produce a simulated activity;
ii) calculating a simulated activity proficiency score for the simulated activity;
iii) comparing the activity proficiency score to the simulated activity proficiency score; and
iv) evaluating whether to update a well plan or rig plan based on the comparing.

Embodiment 50. The method of embodiment 1, wherein the activity includes using machines configured to conduct a subterranean operation.

Embodiment 51. The method of embodiment 1, further comprising identifying an actual activity within the environment by comparing sensor data to a database, which includes reference data for computing the actual activity being performed within the environment.

Embodiment 52. The method of embodiment 51, wherein the reference data includes historical data associated with previously completed activities, and wherein identifying the actual activity includes comparing sensor data to the historical data to identify the actual activity.

Embodiment 53. The method of embodiment 51, wherein reference data includes a list of rig tasks and associated sensor data that occurs for each of the rig tasks, and wherein identifying an actual activity within the environment includes comparing the sensor data to the list of rig tasks and associated sensor data.

Embodiment 54. The method of embodiment 1, further comprising tracking an individual within the environment via one or more sensors and a rig controller.

Embodiment 55. The method of embodiment 1, wherein calculating an activity risk score includes calculating the individual risk score for the individual, wherein the activity risk score indicates a probability a rig and one or more individuals can perform the activity per a well plan, and wherein the individual risk score indicates a probability that the individual can perform the task per a rig plan.

Embodiment 56. The method of embodiment 55, further comprising storing the individual risk score in a database and aggregating individual risk scores over time to evaluate performance of the individual.

Embodiment 57. The method of embodiment 1, wherein the activity risk score is based at least in part upon at least one individual risk score.

Embodiment 58. The method of embodiment 1, further comprising adapting future activities based upon the activity risk score.

Embodiment 59. The method of embodiment 1, further comparing the activity risk score to at least one historical activity risk score and selecting at least one process from the following:
i) training the individual to improve an individual risk score;
ii) updating a well plan including a list of activities to be completed;
iii) updating a rig plan to change tasks associated with one or more individuals;
iv) identifying an alternative pool of individuals to be used to complete the activity or a future activity; or
v) combinations thereof.

Embodiment 60. The method of embodiment 1, further comprising:
i) simulating the activity with at least one different individual to produce a simulated activity;
ii) calculating a simulated activity risk score for the simulated activity;
iii) comparing the activity risk score to the simulated activity risk score; and
iv) evaluating whether to update a well plan or rig plan based on the comparing.

Embodiment 61. A system configured to carry out any of the methods claimed herein.

Embodiment 62. A method for conducting operations in an environment comprising:
conducting an activity of a well plan within an environment;
identifying, via an imaging system, an individual in the environment;
obtaining individual data from an electronic device on the individual;
calculating an individual risk score of the individual for performing a task in support of the activity;
identifying a sensitivity value of the task; and
calculating an activity risk score for the activity based at least in part on the individual risk score and sensitivity value.

Embodiment 63. The method of embodiment 62, wherein the imaging system includes one or more imaging sensors and a rig controller.

Embodiment 64. The method of embodiment 62, wherein identifying the individual further comprises determining, via a rig controller, a unique identity of the individual based on sensor data received from an imaging system.

Embodiment 65. The method of embodiment 64, wherein the rig controller detects one or more characteristics of the individual based on the sensor data.

Embodiment 66. The method of embodiment 65, wherein the one or more characteristics comprise:
a detectable identification number such as an RFID device, a bar code, or a QR code;
physical characteristics of the individual;
mannerisms of the individual;
walking stride of the individual;
motion of the individual;
body movements of the individual;
silhouette of the individual;
size of the individual;
posture of the individual;
body movements of the individual;
facial features of the individual;
an audible signals; or
combinations thereof.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

1. A method for conducting operations in an environment comprising:
conducting an activity of a well plan within an environment;
obtaining individual data from an electronic device on an individual;
calculating an individual risk score of the individual for performing a task in support of the activity; and
calculating an activity risk score for the activity based at least in part on the individual risk score.

2. The method of claim 1, wherein conducting the activity within the environment comprises conducting a subterranean operation.

3. The method of claim 1, wherein conducting the activity comprises conducting an activity on a rig and conducting a task.

4. The method of claim 3, wherein the task of the individual is categorized as a primary task or secondary task.

5. The method of claim 3, further comprising:
identifying a sensitivity value of the task; and
calculating the activity risk score for the activity based at least in part on the individual risk score and the sensitivity value, wherein the task of the individual is categorized as a primary task or secondary task and stored in a database, and wherein a sensitivity value of the task is based at least in part upon the task being a primary task or a secondary task.

6. The method of claim 3, wherein conducting the activity comprises:
determining an actual well activity occurring on the rig;
identifying one or more secondary tasks that are occurring simultaneously with one or more primary tasks;
comparing, via a rig controller, the secondary tasks to a rig plan; and
based on the comparing, determining whether the secondary tasks are occurring at a proper time to support the one or more primary tasks or future primary tasks.

7. The method of claim 6, wherein the actual well activity requires running a drill string into a wellbore.

8. The method of claim 7, wherein the primary tasks for the actual well activity comprise using a pipe handler for retrieving tubulars from a storage area, using a top drive for receiving the tubulars from the pipe handler, repeatedly connecting individual tubulars to an upper end of the drill string, thereby extending the drill string into the wellbore, and wherein the secondary tasks comprise:
verifying at least one characteristic of at least one of the individual tubulars needed to support extension of the drill string into the wellbore.

9. The method of claim 1, wherein the electronic device includes a unique identification number associated with the individual, and wherein the unique identification number is detectable by one or more active or passive detection systems in the environment.

10. The method of claim 1, wherein the environment includes one or more electronic devices configured to communicate with the electronic device on the individual and track movements and actions of the individual in the environment.

11. The method of claim 1, wherein the electronic device is configured to monitor one or more health signals from the individual to calculate the individual risk score of the individual for performing the task.

12. The method of claim 1, further comprising:
identifying a sensitivity value of the task; and
calculating the activity risk score for the activity based at least in part on the individual risk score and the sensitivity value, wherein the electronic device comprises a display configured to display a communication to the individual, wherein such communication includes an alert, a change to the activity, a change to the task, a status of the activity, the individual risk score, the sensitivity value, the activity risk score, an individual proficiency score, an activity proficiency score, or any combination thereof.

13. The method of claim 1, wherein individual data is gathered from the electronic device on the individual and one or more remote sensors observing the individual, and wherein calculating the individual risk score is based on the individual data gathered from the electronic device and data from one or more remote sensors observing the individual.

14. The method of claim 1, wherein the individual risk score includes an initial individual risk score component based at least in part upon historical risk data associated with the individual for an assigned task.

15. The method of claim 1, wherein the individual risk score includes a real-time individual risk score component based at least in part upon comparing an expected characteristic of the individual to an actual characteristic of the individual.

16. The method of claim 1, wherein calculating the individual risk score comprises:
assigning an initial individual risk score component to an individual for the task, wherein the initial individual risk score component is based at least in part upon historical risk data associated with the individual for the task or for a similar task; and
calculating a real-time individual risk score by updating the initial individual risk score component with a real-time individual risk score component, wherein calculating the real-time individual risk score is based at least in part upon comparing an expected characteristic of the individual to an actual characteristic of the individual.

17. The method of claim 16, further comprising sending the real-time individual risk score to the electronic device on the individual or storing the real-time individual risk score in one or more databases.

18. The method of claim 16, further comprising adapting the task based upon the real-time individual risk score.

19. The method of claim 16, further comprising calculating an updated activity risk score for the activity based at least in part on the real-time individual risk score.

20. The method of claim 1, further comprising:
identifying an actual task of the individual by at least one of:
i) referencing a database having stored information related to the actual task of the individual;
ii) sensing the actual task of the individual via one or more sensors in the environment;
iii) actively confirming the actual task of the individual with the individual via the electronic device; or
iv) combinations thereof.
